(19) United States
(12) Patent Application Publication
(10) Pub. No.: US 2026/0291683 A1
(43) Pub. Date: Sep. 24, 2026

(54) QCL INDICATION FOR PDP ESTIMATION

(71) Applicant: QUALCOMM Incorporated, San Diego, CA (US)

(72) Inventors: Somsubhra BARIK, San Diego, CA (US); Jing SUN, San Diego, CA (US); Chih-Hao LIU, San Diego, CA (US)

(21) Appl. No.: 19/088,705

(22) Filed: Mar. 24, 2025

(51) Int. Cl. H04L 5/00; H04B 7/06

(52) U.S. Cl. CPC H04L 5/0051; H04B 7/0617

(57) ABSTRACT

The apparatus may be a wireless device configured to receive, for at least a first port associated with a first slot that follows a second slot, a first indication of a type of quasi-co-location (QCL) of a first set of demodulation reference signals (DMRSs) of the first port with a second DMRS of a second port associated with the second slot, wherein the first indication of the type of QCL is based on a relationship between a first precoding associated with the first DMRS and a second precoding associated with the second DMRS, updating, based on the first DMRS, a parameter associated with the first indication, wherein the parameter is an input for a channel estimation, demodulating, based on the updated parameter, data in the first slot, and outputting a second indication of the demodulated data.

### INTRODUCTION

The present disclosure relates generally to communication systems, and more particularly, to wireless communication that includes channel estimation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later wireless communication, such as 6G or others, may be based on aspects of 5G NR and/or 4G LTE. There exists a need for further improvements, in 5G NR and additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication is provided. The method may be performed by a wireless device such as a user equipment (UE) and include receiving, for at least a first port associated with a first slot that follows a second slot, a first indication of a type of quasi-co-location (QCL) of a first demodulation reference signal (DMRS) of the first port with a second DMRS of a second port associated with the second slot, wherein the first indication of the type of QCL is based on a relationship between a first precoding associated with the first DMRS and a second precoding associated with the second DMRS, updating, based on the first DMRS, a parameter associated with the first indication, wherein the parameter is an input for a channel estimation, demodulating, based on the updated parameter, data in the first slot, and outputting a second indication of the demodulated data.

In an aspect of the disclosure, a computer-readable medium is provided. The computer-readable medium may store computer executable code at a UE, and the code when executed by one or more processors causes the UE to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data.

In an aspect of the disclosure, an apparatus for wireless communication is provided. The apparatus may be an apparatus for wireless communication at a UE including one or more memories, and one or more processors coupled to the one or more memories and configured to cause the UE to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data.

In an aspect of the disclosure, an apparatus for wireless communication is provided. The apparatus may be an apparatus for wireless communication at a UE, including means for receiving, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, means for updating, based on the first DMRS, a parameter associated with the first indication, wherein the parameter is an input for a channel estimation, means for demodulating, based on the updated parameter, data in the first slot, and means for outputting a second indication of the demodulated data.

In an aspect of the disclosure, a method of wireless communication is provided. The method may be performed by a network device and include outputting, for a UE and for at least a first port associated with a first slot following a second slot, a first indication of a type of QCL of a first DMRSs of the first port with a second DMRS of a second port associated with the second slot, wherein the indication of the type of QCL is based on a relationship between a first precoding associated with the first DMRS and a second precoding associated with the second DMRS, and outputting, for the UE, the first DMRS and first data in the first slot.

In an aspect of the disclosure, a computer-readable medium is provided. The computer-readable medium may store computer executable code at a network device, and the code when executed by one or more processors causes the network device to output, for a UE and for at least a first port associated with a first slot following a second slot, a first indication of a type of QCL of a first DMRSs of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot.

In an aspect of the disclosure, an apparatus for wireless communication is provided. The apparatus may be an apparatus for wireless communication at a network device including one or more memories, and one or more processors coupled to the one or more memories and configured to cause the network device to output, for a UE and for at least a first port associated with a first slot following a second slot, a first indication of a type of QCL of a first DMRSs of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot.

In an aspect of the disclosure, an apparatus for wireless communication is provided. The apparatus may be an apparatus for wireless communication at a network device, including means for outputting, for a UE and for at least a first port associated with a first slot following a second slot, a first indication of a type of QCL of a first DMRSs of the first port with a second DMRS of a second port associated with the second slot, wherein the indication of the type of QCL is based on a relationship between a first precoding associated with the first DMRS and a second precoding associated with the second DMRS, and means for outputting, for the UE, the first DMRS and first data in the first slot.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a base station in communication with a UE in an access network, in accordance with various aspects of the present disclosure.

FIG. 5 is a diagram illustrating aspects associated with an indication of a type of QCL of a first DMRS of a first port with a second DMRS of a second port in accordance with some aspects of the disclosure.

FIG. 6A is a diagram illustrating some aspects of an indication of a type of QCL between a first DMRS and a second DMRS in accordance with some aspects of the disclosure.

FIG. 6B is a diagram illustrating some aspects of an indication of a type of QCL between a series of DMRSs in accordance with some aspects of the disclosure.

FIG. 7A uses a first threshold (e.g., identified by a value K=1) to identify, for a first precoding, that precodings are similar and may be indicated to be QCL'ed with the first precoding.

FIG. 7B uses a second threshold (e.g., identified by a value K=2) to identify, for a first precoding, that precodings and precoding are similar and may be indicated to be QCL'ed with the first precoding.

FIG. 7C uses a third threshold (e.g., identified by a value K=3) to identify, for a first precoding, that precodings, precoding, and precodings are similar and may be indicated to be QCL'ed with the first precoding.

FIG. 8 is a call flow diagram illustrating a method of wireless communication in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an apparatus.

FIG. 14 is a diagram illustrating an example of a hardware implementation for a network entity.

### DETAILED DESCRIPTION

In some aspects of wireless communication, a receiver may decode a received signal may based on a channel estimation performed at the receiver (e.g., a receiving device such as a UE or other wireless device). The channel estimation, in some aspects, may be based on one or more reference signals, e.g., a tracking reference signal (TRS) or a DMRS, among other example reference signals. In some aspects, to estimate a channel (e.g. to generate a channel estimation) a UE may determine, or calculate, a power delay profile (PDP) or frequency domain (FD) correlation associated with the channel. The PDP or FD correlation may be based on one or more reference signals used for the channel estimation, e.g., the TRS or the DMRS. In some aspects, the PDP or FD correlation may be applied to, or used as an input for, a minimum mean squared error (MMSE) based channel estimation. For example, in some aspects, the MMSE matrix may be quantized as a function of a delay spread of the PDP, where the receiver may estimate the delay spread of PDP and select and/or determine the MMSE matrix accordingly.

The term channel may be used to describe the effect of (e.g., a distortion introduced by) signal propagation from a transmitter to a receiver for a transmitter-receiver pair. A channel, in some aspects, may be characterized by an impulse response, e.g., a signal received at the receiver based on a single sample transmitted by the transmitter. A mathematical representation of a channel between a transmitter and a receiver may be a matrix H that describes the relationship between a signal x transmitted by a transmitter and a signal y received at a receiver based on the channel in the absence of noise. For example, assuming an additional noise term, n, The relationship between x and y may be expressed as y=Hx+n. A channel estimation may refer to a process for estimating the matrix H and may be associated with a MMSE equalization matrix M that minimizes a mean squared error between a transmitted signal x and an equalized received signal My. In order to calculate the MMSE, the receiver may use knowledge of the transmitted signal x associated with one or more reference signals such as the TRS or DMRS.

A delay spread or PDP, in some aspects, may be associated with a signal that travels over a plurality of different paths that make up a channel associated with communication between a transmitter of the signal and a receiver of the signal. The signal traveling over the different paths may arrive at the receiver at a corresponding plurality of different times and with a corresponding plurality of powers that may be used to calculate one or more measures of the delay spread of the channel. Measures of delay spread such as a max delay spread, an average delay spread, or a root mean square (RMS) delay spread, in some aspects, may describe different aspects of the channel (e.g., the delay spread or PDP associated with the channel). In some aspects, a receiver may compute, or calculate, an FD correlation and/or an average PDP of the received channel Ĥ(k) (where Ĥ(k) may represent a noisy channel matrix that is a combination of the channel matrix H and the noise term n such that a received signal may be represented as y=Ĥx) using the following equation for the FD correlation:

$${R}_{\hat{H} \hat{H} , l} [ k ] = {\sum }_{r} {\sum }_{PRG} 1 / N ( k ) {\sum }_{m} {\hat{H}}_{r , l} ( k + m ) {\hat{H}}_{r , l} * ( m )$$

In this example, Ĥ_{r,l}(m) denotes the received channel at tone index ‘m’ (an m^{th} subcarrier), antenna ‘r’, and associated with an ‘l^{th}’ layer, and N(k) denotes the number of tones (or subcarriers) available for averaging for a tone offset of k.

Some aspects of wireless communication may be based on a quasi-co-location (QCL) relationship between signals, e.g., a correlation with respect to large scale channel characteristics between signals from different antenna ports. The correlation may be based on a reference signal, in some aspects. As an example, QCL Type A may indicate a correlation with respect to Doppler shift, Doppler spread, average delay, and delay spread. QCL Type B may indicate a correlation with respect to Doppler shift and Doppler spread. QCL Type C may indicate a correlation with respect to average delay and Doppler shift. QCL Type D may indicate a correlation with respect to a spatial parameter (e.g., between directional beams.

In some aspects, a type of QCL relationship (which may be referred to as a QCL Type E or Type E QCL) may indicate that the average FD correlation and/or the average PDP (e.g., averaged over the precoding resource groups (PRGs) of the channel), or an average delay and average delay spread, are equivalent for the quasi-co-located (QCL'ed) ports (e.g., DMRS ports). Equivalent average delays and average delay spreads, in some aspects, may refer to average delays and average delay spreads for different signals that meet a similarity criterion (or multiple similarity criteria) that may be defined based on the use of the average delay and average delay spread indicated by the QCL relationship. For example, the type of QCL may indicate that a subset of characteristics and/or parameters associated with an antenna port are correlated with (e.g., which may be referred to as shared with, inherited by, etc.) the same subset of characteristics and/or parameters associated with the QCL'ed ports. In some aspects, the subset of characteristics or parameters indicated by a QCL relationship may be used for a channel estimation, for example. A QCL Type E relationship may further be associated with a loop filter/loop filtering or other combining operation between currently calculated values for the average FD correlation and/or the average PDP or an average delay and average delay spread and stored values based on one or more previous signals having the same QCL type relationship (e.g., being QCL'ed to a same reference port). A QCL Type E relationship may be based on a similarity criterion for identifying the QCL Type E relationship between two signals that is based on the QCL'ed signals being associated with an identical precoding (e.g., precoding matrix) applied at the transmitter. In some aspects, a transmission configuration indicator (TCI) state may be defined for each of a plurality of identifiable QCL Type E relationships. As will be described in more detail below, the similarity criterion based on being associated with an identical precoding, may be overly restrictive and be associated with one or more of a large amount of signaling overhead for identifying (and a large amount of memory usage to store the values for parameters associated with) each different precoding, a large number of different TCI states used to identify each unique precoding, and/or being limited to a subset of the precodings to reduce the signaling overhead (and memory usage), for example.

Various aspects relate generally to a mechanism for improved channel estimation in wireless communication systems by allowing the network to dynamically indicate a type of QCL information (e.g., which may be referred to as QCL Type E information or QCL Type E) for one or more scheduled DMRS port, to enable use of FD correlations and combination across slots. Some aspects more specifically relate to a type of QCL (e.g., which may be referred to as a generalized QCL or a generalized QCL Type E) indication based on at least one of an average FD correlation and/or average PDP, a precoder class or codebook, and/or a measure of precoder similarity (or dissimilarity). In some aspects, the UE may indicate and/or report a suggested measure of precoder similarity (or dissimilarity) associated with QCL'ed signals from a set of profiles (similarity profiles or QCL Type E indication configurations). The set of profiles, in some aspects, may be known (e.g., pre-configured) or configured profiles QCL Type E. In some examples, a UE may be configured to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data. A base station, in some examples, may be configured to output, for a UE and for at least a first port associated with a first slot following a second slot, a first indication of a type of QCL of a first DMRS of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot.

In some examples, by using the indication of the type of QCL that is based on a relationship between a first precoding and a second precoding, the described techniques can be used to filter a parameter used as an input to a channel estimation across slots to improve the accuracy and/or usefulness of the parameter. In some examples, by relaxing a similarity criterion for QCL from an identity of precoders (e.g., that precoders be identical) to a similarity of precoders (e.g., that precoders be sufficiently similar), e.g., allowing an indication of a QCL relationship for non-identical precoders/precodings, the described techniques may allow, or provide, an improved accuracy of a parameter (e.g., a PDP, FD correlation, average delay, or average delay spread) based on QCL where it was previously not allowed, and enable an improved accuracy of channel estimation based on the improved input. In some examples, by providing multiple selectable similarity profiles, the described techniques may allow a UE to determine an optimization between increased accuracy of QCL-based channel estimations and increased signaling overhead associated with a larger number of indicatable and/or activatable TCI states associated with QCL classes based on a higher degree of similarity.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspects. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

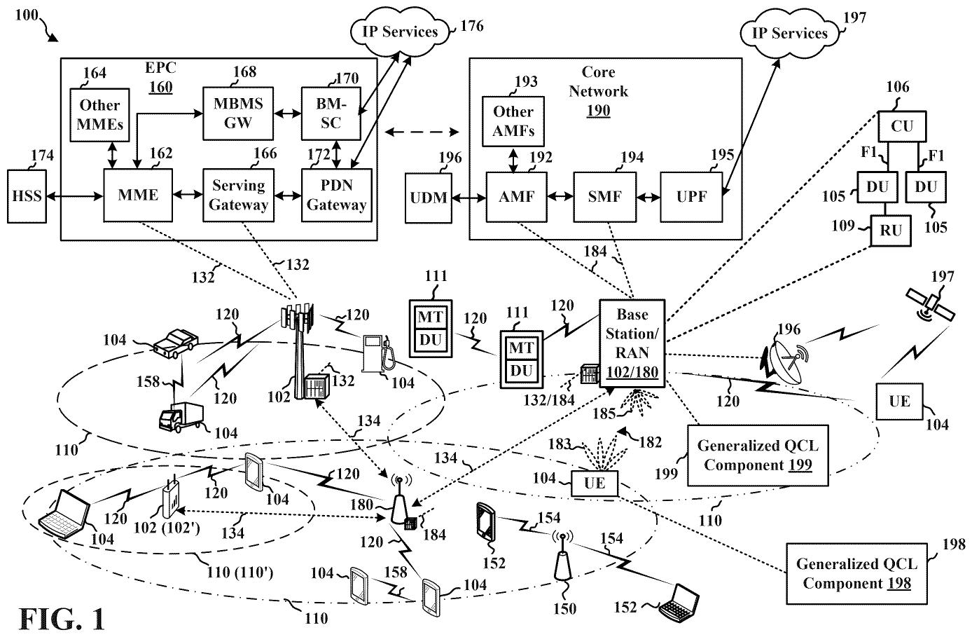

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a generalized QCL component 198 that may be configured to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data. In certain aspects, the base station 102 may have a generalized QCL component 199 that may be configured to output, for a UE and for at least a first port associated with a first slot following a second slot, a first indication of a type of QCL of a first DMRS of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot. While discussed for a single DMRS and/or port, a plurality of indications may be received for a plurality of DMRS (or sets of DMRSs) and/or ports, or a single indication may apply to a plurality of DMRS (or sets of DMRSs) and/or ports.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

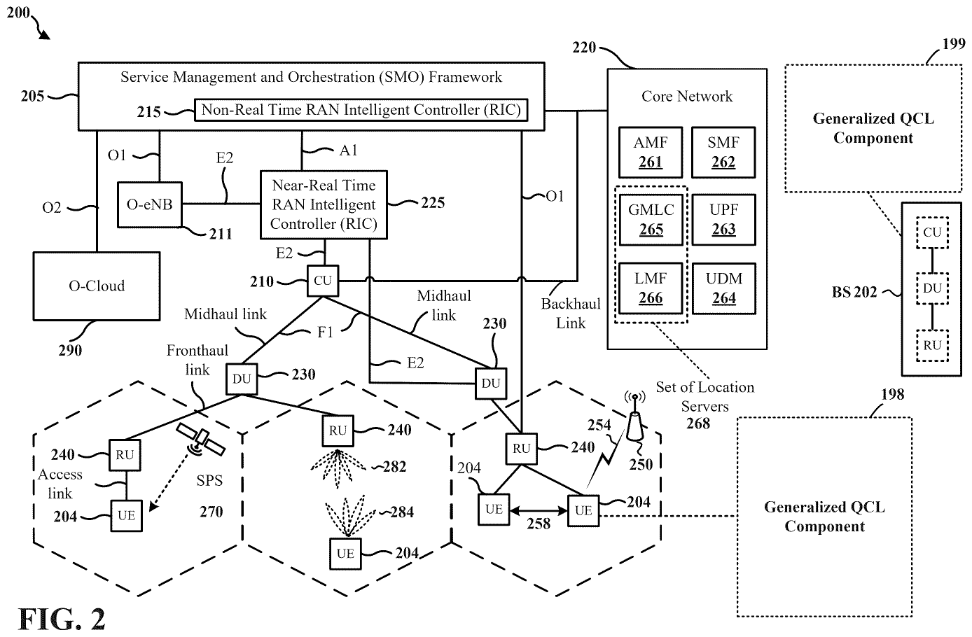

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position associated with the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have a generalized QCL component 198 that may be configured to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data. Similar to the base station 102 in FIG. 1, in certain aspects, the base station 202 may have a generalized QCL component 199 that may be configured to output, for a UE and for at least a first port associated with a first slot following a second slot, a first indication of a type of QCL of a first DMRS of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot. While discussed for a single DMRS and/or port, a plurality of indications may be received for a plurality of DMRS (or sets of DMRSs) and/or ports, or a single indication may apply to a plurality of DMRS (or sets of DMRSs) and/or ports.

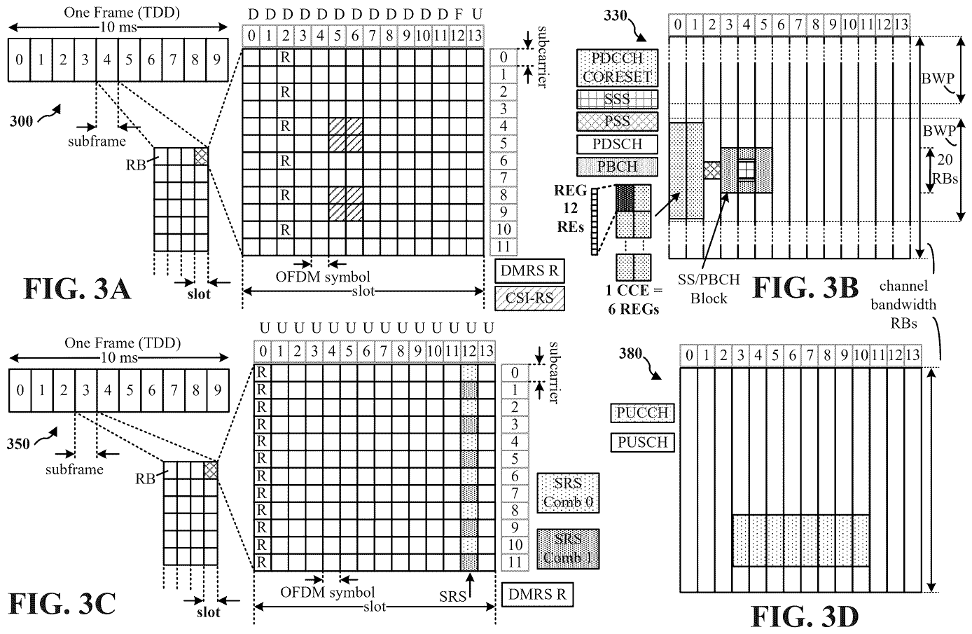

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

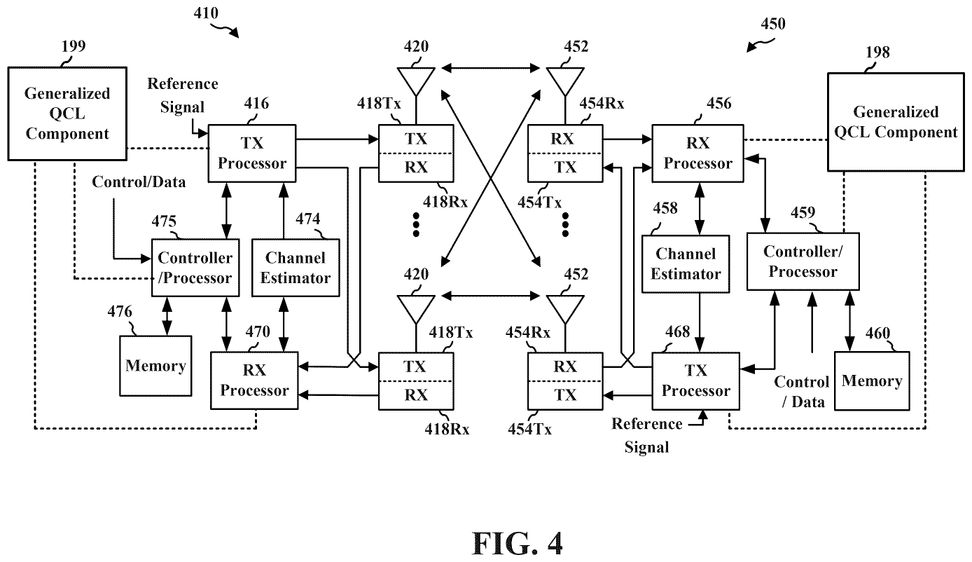

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the generalized QCL component 198 of FIG. 1.

At least one of the TX processor 416, the RX processor 470, and the controller/processor 475 may be configured to perform aspects in connection with the generalized QCL component 199 of FIG. 1.

In some aspects of wireless communication, a receiver may decode a received signal based on a channel estimation performed at the receiver (e.g., a receiving device such as a UE or other wireless device). The channel estimation, in some aspects, may be based on one or more reference signals, e.g., a TRS or a DMRS, among other example reference signals. In some aspects, to estimate a channel (e.g. to generate a channel estimation) a UE may determine, or calculate, a power delay profile (PDP) or frequency domain (FD) correlation associated with the channel. The PDP or FD correlation may be based on one or more reference signals used for the channel estimation, e.g., the TRS or the DMRS. In some aspects, the PDP or FD correlation may be applied to, or used as an input for, a minimum mean squared error (MMSE) based channel estimation. For example, in some aspects, the MMSE matrix may be quantized as a function of a delay spread of the PDP or the FD correlation, where the receiver may estimate the delay spread of PDP or FD correlation and select and/or determine the MMSE matrix accordingly.

In some aspects, a type of QCL relationship (which may be referred to as a QCL Type E or Type E QCL) may indicate that the average FD correlation and/or the average PDP (e.g., averaged over the precoding resource groups (PRGs) of the channel), or an average delay and average delay spread, are equivalent for the quasi-co-located (QCL'ed) ports (e.g., DMRS ports). Equivalent average delays and average delay spreads, in some aspects, may refer to average delays and average delay spreads for different signals that meet a similarity criterion (or multiple similarity criteria) that may be defined based on the use of the average delay and average delay spread indicated by the QCL relationship. For example, the type of QCL may indicate that a subset of characteristics and/or parameters associated with an antenna port are correlated with (e.g., which may be referred to as shared with, inherited by, etc.) the same subset of characteristics and/or parameters associated with the QCL'ed ports. In some aspects, the subset of characteristics or parameters indicated by a QCL relationship may be used for a channel estimation, for example. A QCL Type E relationship may further be associated with a loop filter/loop filtering or other combining operation between a currently calculated values for the average FD correlation and/or the average PDP or an average delay and average delay spread, and stored values based on one or more previous signals having the same QCL type relationship (e.g., being QCL'ed to a same reference port). A QCL Type E relationship may be based on a similarity criterion for identifying the QCL Type E relationship between two signals that is based on the QCL'ed signals being associated with an identical precoding (e.g., precoding matrix) applied at the transmitter. In some aspects, a transmission configuration indicator (TCI) state may be defined for each of a plurality of identifiable QCL Type E relationships. As will be described in more detail below, the similarity criterion based on being associated with an identical precoding, may be overly restrictive and be associated with one or more of a large amount of signaling overhead for identifying (and a large amount of memory usage to store the values for parameters associated with) each different precoding, a large number of different TCI states used to identify each unique precoding, and/or being limited to a subset of the precodings to reduce the signaling overhead (and memory usage), for example.

Various aspects relate generally to a mechanism for improved channel estimation in wireless communication systems by allowing the network to dynamically indicate a type of QCL information (e.g., which may be referred to as QCL Type E information) for one or more scheduled DMRS port, to enable use of FD correlations and combination across slots. Some aspects more specifically relate to a type of QCL (e.g., which may be referred to as a generalized QCL or a generalized QCL Type E) indication based on at least one of an average FD correlation and/or average PDP, a precoder class or codebook, and/or a measure of precoder similarity (or dissimilarity). In some aspects, the UE may indicate and/or report a suggested measure of precoder similarity (or dissimilarity) associated with QCL'ed signals from a set of profiles (similarity profiles or QCL Type E indication configurations). The set of profiles, in some aspects, may be known (e.g., pre-configured) or configured profiles. In some examples, a UE may be configured to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data. A base station, in some examples, may be configured to output, for a UE and for at least a first port associated with a first slot following a second slot, a first indication of a type of QCL of a first DMRS of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot.

The receiver may maintain, or store, information regarding the computed FD correlations or PDPs in multiple slots and can leverage, or use, the maintained, or stored, information for channel estimation for current and/or subsequent slots. For example, in some aspects, the UE may store PDPs associated with multiple slots and filter PDPs across slots (e.g., across slots having equivalent FD correlations or equivalent PDPs and/or a QCL Type E relationship) to help improve channel estimation performance of a current slot.

In some aspects, a transmitter (e.g., a base station) may dynamically indicate QCL information (e.g., QCL Type E information) per scheduled DMRS port in a slot. Based on the indicated QCL information (e.g., the indication of a QCL Type E), a receiver (e.g., a UE) may exploit, or use, previously estimated (and stored) FD correlations or average PDPs per port by combining the previously estimated FD correlations or average PDPs for QCL'ed ports across slots (e.g., when the DMRS ports use the same, or equivalent, spatial precoders across these slots). Additionally, the UE has full control to fine-tune the FD correlation or average PDP for a current slot based on the history and time-separation of QCL'ed transmissions, e.g., to apply weights to stored FD correlations or average PDPs based on the time elapsed since they were computed and/or estimated. In some aspects, the type of QCL (e.g., the generalized QCL or QCL Type E) may indicate a QCL source and may also indicate for the UE to update the parameter associated with the QCL source.

An earlier DMRS port may be indicated to be a QCL source of a later DMRS port for a QCL Type E. A QCL reference signal (or QCL source), in some aspects, may be indicated using index types or slot pointers. The index types or the slot pointers may indicate, or be mapped to, one or more earlier physical downlink shared channel (PDSCH) transmissions whose DMRS ports are the QCL source (e.g., a QCL Type E of the later DMRS port). For example, a transmitter may include an indication of a QCL type for a particular signal (e.g., a DMRS) in a particular slot (e.g., slot m+n, n>0) with a previous slot (e.g., slot m). Based on the indication of the QCL type, the UE may perform a channel estimation using a combined estimated, or computed, PDP based on the particular signal in slot m+n and the QCL source (e.g., a DMRS in the slot m). For example, the UE may execute, or run time-domain filtering loops corresponding to the DMRS ports (e.g., the QCL'ed ports) and update loops for the scheduled ports in slot m+n.

As described above, a type of QCL (e.g., a generalized QCL, a QCL Type E or generalized QCL Type E) may provide a mechanism (to indicate for a UE) to use earlier DMRS (e.g., DMRS received in one or more earlier slots) to estimate, or compute, a PDP (or average PDP) at a UE port and apply, or use, the estimated PDP to estimate, or compute a PDP of a later DMRS (where the estimated PDP of the later DMRS may be used for a channel estimation of, or associated with, the later DMRS). The QCL indication (for a QCL Type E) may include a field (e.g., a reference index field) including a value (or index) into an indexed set of QCL sources. The indexed set of QCL sources, in some aspects, may include a set of candidate slots that may be used as a QCL source (e.g., a reference slot for the QCL Type E). For example, for a QCL indication for a slot n, the reference index field may include x bits that may be used to indicate that the reference slot is one of a set of 2^{x} previous slots (e.g., slot n−2^{x} to slot n−1). If the field is only one bit, the value may indicate whether the current slot is QCL'ed with an immediately previous slot or is not QCL'ed with the previous slot. The QCL indication (e.g., indicating a QCL Type E), in some aspects, may apply specifically to a DMRS or other specific signal such that referring to a slot as being QCL'ed with a reference slot may be understood as the DMRS in the slot being QCL'ed with a DMRS in the reference slot.

In some aspects, the indexed set of QCL sources may include an indexed set of candidate QCL classes that may be used to identify one or more QCL sources (e.g., one or more reference slots). For example, a particular value in the field of the QCL indication (indicating a particular class) may identify, or be used to identify, one or more reference slot(s) indicated, e.g., in a QCL indication for the one or more reference slot(s), to be associated with the same class. For the QCL indication (e.g., the QCL Type E indication), signals, channels, and/or ports having a same precoder (e.g., having a same precoder, or precoding matrix, applied by the transmitting device) may be considered, or assumed, to have identical FD correlations and PDPs. Generally, a transmitter such as a base station or network device may assume that, for a same set of physical conditions, the FD correlations and PDPs (or average FD correlations and average PDPs) of a signal, channel, and/or port may be based on, or related to, the precoder applied to the signal, channel, and/or port by the transmitter such that a FD correlation and/or PDP may be estimated based on the applied precoder.

When using either the set of candidate slots or candidate classes, the indication may indicate, or be mapped to, a particular stored PDP or filtered PDP (e.g., a PDP based on a single slot or based on a filtering applied to a plurality of slots to refine a PDP estimation and/or computation). The filtering (or combining) operation, in some aspects, may be (as non-limiting examples) a loop filter/filtering, an IIR filter/filtering, or any other combining operation determined by, or configured for, the UE. For example, the filtered PDP may be the result of an infinite impulse response (IIR) filter, e.g., a first order IIR filter, PDP_{filtered}(slot_{current})=α*PDP_{filtered}(slot_{ref})+(1−α)*PDP(slot_{current}), where α (with 0≤α≤1) is a weight term indicating the relative contribution of a PDP estimated and/or computed based on a signal (e.g., a DMRS that may include a set of DMRS tones) received in a current slot (e.g., the PDP(slot_{current}) term for the current slot, slot current) and a filtered PDP estimated and/or computed for a reference slot (e.g., the PDP_{filtered}(slot_{ref}) term for the reference slot, slot_{ref}) based on a signal (e.g., a DMRS) received in the reference slot and based on at least one signal(s) received in at least one previous slot(s) incorporated in, or used to estimate, or compute, the stored filtered PDP value. If the stored PDP is based on a single previous slot, the PDP_{filtered}(slot_{ref}) may be replaced with a PDP(slot_{ref}) term indicating that the stored PDP is based solely on the signal received in the reference slot.

While identifying each candidate QCL class with a unique precoder may allow for indication of a reference source having an identical FD correlation and PDP, a large number of precoders may be used by a base station serving multiple UEs for a rapidly varying multi-user environment. Using a large number of candidate QCL index values, in some aspects, may allow for the indication of a large number of candidate reference slots, candidate QCL classes, and may provide for a greater likelihood of being able to identify a QCL'ed reference slot, QCL class. In some aspects, using the large number of candidate QCL index values may also be associated with large DCI signaling overhead to enable unique identification of each candidate reference slot and candidate QCL class (which may be associated with a large number of active TCI states). The signaling overhead may be further increased if per-port QCL indication is used and/or if the transmission is of a higher rank. In addition to the signaling overhead, more memory resources may need to be allocated to store the (filtered) PDP information for larger numbers of candidate reference slots and/or candidate QCL classes. To reduce overhead while maintaining the benefit of the QCL indication of the reference PDP, each of the candidate QCL classes may be associated with a set of precoders having sufficiently similar expected average FD correlations and/or average PDPs.

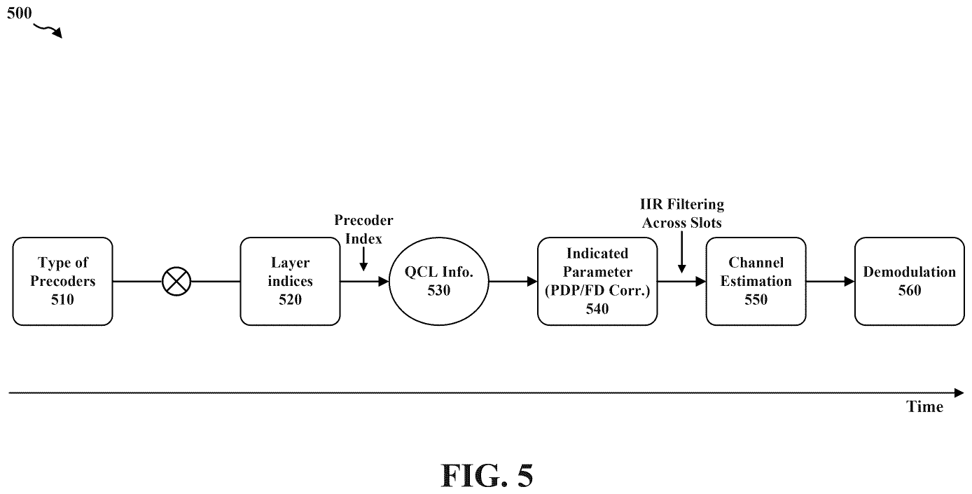

FIG. 5 is a diagram 500 illustrating aspects associated with an indication of a type of QCL of a first DMRS of a first port with a second DMRS of a second port in accordance with some aspects of the disclosure. Diagram 500 illustrates that a base station may take into account, or select, a type of precoder (e.g., from, or at, the type of precoders 510) and layer indices 520 to generate a set of precoder indexes (e.g., a QCL class index that may be associated with QCL information to identify a QCL'ed port or signal). The precoder index (or QCL class index) may be included in QCL information 530 (e.g., in an indication of a type of QCL, such as QCL Type E). In some aspects, the indicated QCL may be used to identify a stored parameter 540 or information. The parameter, or information, associated with the indicated QCL may be a FD correlation or PDP, or, more generally, may refer to a characteristic of the channel and/or a set of values associated with the parameter/characteristic such as a set of data indicating a received power as a function of time delay that may be used for a channel estimate. In some aspects the indication also indicates for the UE to perform a filtering operation (e.g., an IIR filtering based on the DMRS received in the current slot and the stored value identified by the indication of the type of QCL). The updated parameter (e.g., FD correlation or PDP) may then be used as an input to a channel estimation 550, which may, in turn, be used for a demodulation 560.

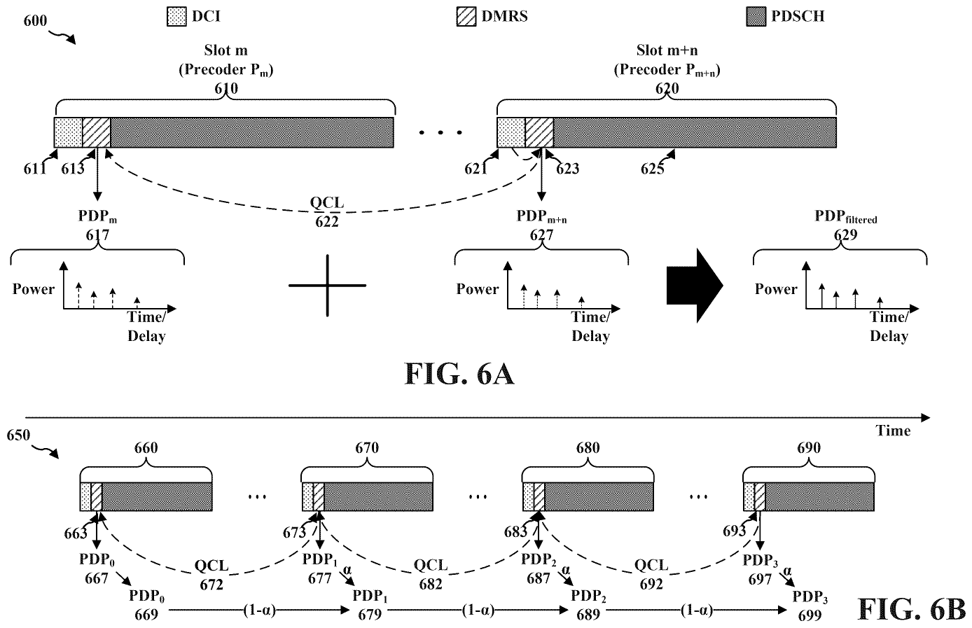

FIG. 6A is a diagram 600 illustrating some aspects of an indication of a type of QCL between a first DMRS 613 and a second DMRS 623 in accordance with some aspects of the disclosure. Diagram 600 illustrates that a slot 610 (e.g., slot m) may be received prior to a slot 620 (e.g. slot m+n) and that DCI 621 may indicate a QCL 622 (e.g., a QCL Type E relationship) of DMRS 623 to DMRS 613 of slot 610. The QCL 622, in some aspects, may be based on an index or value included in the DCI 621 that is associated with the slot 610 and the DMRS 613. The index or value may be configured to identify and/or indicate a slot-based QCL indication or a class-based QCL indication (e.g., the index may identify a QCL class from a known set of QCL classes using a QCL class index). As a non-limiting example, the parameter indicated to be the same, by the indication of the QCL 622, between the DMRS 623 and the DMRS 613 is illustrated as being a PDP. The UE may retrieve a stored PDP 617 associated with the QCL class index and/or associated with the slot 610 (or, more specifically, the DMRS 613), and estimate and/or compute a PDP 627 based on the DMRS 623. The UE may then combine the retrieved PDP 617 and the estimated and/or computed PDP 627. In some aspects, the combination is based on a filter, e.g., an IIR filter, where the IIR filter may apply a function such as PDP_{filtered}(slot_{current})=(1−α)*PDP_{filtered}(slot_{ref})+α*PDP(slot_{current}), to arrive at PDP 629 (e.g., the PDP_{filtered}(slot_{current})), where a (with 0≤α≤1) is a weight term associated with the relative contribution of a PDP estimated and/or computed based on a signal (e.g., a DMRS that may include a set of DMRS tones) received in a current slot (e.g., the PDP (slot current) term for the current slot, slot_{current}, or slot 620 in FIG. 6A) and a filtered PDP estimated and/or computed for a reference slot (e.g., the PDP_{filtered}(slot_{ref}) term for the reference slot, slot_{ref}, or slot 610 in FIG. 6A) based on a signal (e.g., the DMRS 613) received in the reference slot (e.g., the slot 610) and based on at least one signal(s) received in at least one previous slot(s) incorporated in, or used to estimate, or compute, the stored filtered PDP value. If the stored PDP is based on a single previous slot, the PDP_{filtered}(slot_{ref}) may be replaced with a PDP(slot_{ref}) term indicating that the stored PDP is based solely on the signal received in the reference slot. The PDP 629 (e.g., a filtered and/or updated PDP) may then be stored by the UE in association with the QCL class index indicated in DCI 611 or in association with the slot 620.

In some aspects, DCI 611 of slot 610 may have included an indication of a QCL to a previous slot (e.g., a slot m-n, not shown) such that the PDP 617 may be the result of a previous process similar to that described for slot 620. Accordingly, the UE may benefit from the filtering across multiple slots that produces a more accurate estimation or computation of PDP. When the more accurate PDP is used as an input to a channel estimation, the UE may benefit from an improved channel estimation. As described in relation to FIG. 5, the filtered and/or updated PDP 629 may be used for a channel estimation and eventually to demodulate and/or decode data 625 of the slot 620.

FIG. 6B is a diagram 650 illustrating some aspects of an indication of a type of QCL between a series of DMRSs in accordance with some aspects of the disclosure. Diagram 650 illustrates a slot 660, a slot 670, a slot 680, and a slot 690 including a DMRS 663, a DMRS 673, a DMRS 683, and a DMRS 693. Diagram 650 illustrates that a QCL 692, a QCL 682, and a QCL 672 may be indicated for the pairs of DMRS, DMRS 693 and DMRS 683, DMRS 683 and DMRS 673, and DMRS 673 and DMRS 663, respectively. The DMRS 663 may be a first DMRS associated with a QCL class and may be used to initialize a PDP 669 associated with the QCL class based on the DMRS 663 and a computed PDP 667 and stored for subsequent slots. Based on the indication of the QCL 672, the PDP 669 may be updated based on the DMRS 673 and a computed PDP 677 to produce an updated PDP 679 that may be stored in place of the PDP 669 and may be used for subsequent slots. Based on the indication of the QCL 682, the PDP 679 may be updated based on the DMRS 683 and a computed PDP 687 to produce an updated PDP 689 that may be stored in place of the PDP 679 and may be used for subsequent slots. Based on the indication of the QCL 692, the PDP 689 may be updated based on the DMRS 693 and a computed PDP 697 to produce an updated PDP 699 that may be stored in place of the PDP 689 and may be used for subsequent slots. In some aspects, the accuracy of the stored PDP may improve over time as more data (DMRS tones) is collected and used to refine the stored PDP.

In some aspects, the generalized QCL indication may, instead of identifying a reference slot or reference signal having an identical precoding, indicate a relationship between a first precoding applied to a particular port and/or layer in a particular slot and a second precoding applied to a reference/source port and/or layer in a reference/source slot. The generalized QCL indication, in some aspects, may indicate a parameter that is common to (or sufficiently similar across) the first precoding and the second precoding, such as an average FD correlation or average PDP being sufficiently similar. While the similarity may be identified at a base station based on an UL channel estimate assuming channel reciprocity, or based on explicit UE feedback regarding an estimated parameter (e.g., PDP or FD correlation) or its correlation with previously estimated values, in some aspects, the base station may rely on the similarity of the first and second precoding to determine whether to indicate a generalized QCL relationship. Using the similarity of the precodings may avoid an inaccuracy of a QCL determination based on an UL channel estimate where there is a UL/DL mismatch leading to a mistaken indication of a QCL relationship, and/or may avoid the overhead and/or complexity associated with determining the QCL relationship based on the explicit UE feedback regarding an estimated parameter associated with the QCL relationship.

When considering the similarity of a first and second precoding, the base station may use different criteria. For example, when using open loop beamforming, precoders may be identified as being related for the type of QCL (e.g., classified) in at least the following two ways. In some aspects, each of the plurality of candidate QCL classes, may be associated with a set of precoders sharing a precoder class or type (e.g., any of a Hadamard precoding, a discrete Fourier transform (DFT) precoding, or cyclic delay diversity (CDD) precoding). In some aspects, when candidate QCL classes are based on using a same precoder class or type, all ports of a first slot may be indicated to be QCL'ed with all ports of the second slot. When using a precoder cycling, each of the plurality of candidate QCL classes may be associated with a different codebook of precoders (e.g., based on the assumption that cycling the precoders of the codebook across PRGs results in a sufficiently similar average FD correlation and/or PDP).

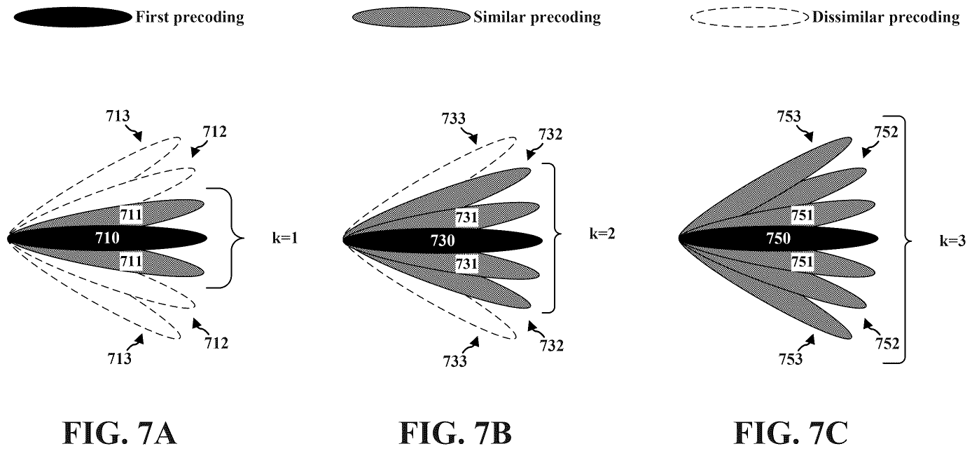

When using closed loop beamforming, precoders may be classified based on a similarity criterion (or multiple similarity criteria), where a codebook resolution in spatial domain may determine the similarity of average PDP estimated based on any two precoders from the codebook. For example, precodings in a codebook may be clustered together to down-size to a set of representative precoders (or precodings) and a base station may identify a first precoding to be similar to a second precoding (e.g., QCL'ed with the second precoding) based on the first and second precodings belonging to a same cluster. FIG. 7A-7C illustrate different thresholds for that may be used to determine similarity between precodings in a spatial domain in accordance with some aspects of the disclosure. FIG. 7A uses a first threshold (e.g., identified by a value k=1) to identify, for a first precoding 710, that precodings 711 are similar and may be indicated to be QCL'ed with the first precoding 710. Accordingly, for precoding 710 either of the precodings 711, but none of the precodings 712 or the precodings 713, may belong to the same cluster, where a cluster may be determined based on the precoding used for a particular slot such that if one of the precodings 711 was used for a particular slot, the other precoding 711 may not be identified as being in a same cluster.

FIG. 7B uses a second threshold (e.g., identified by a value k=2) to identify, for a first precoding 730, that precodings 731 and precoding 732 are similar and may be indicated to be QCL'ed with the first precoding 730. Accordingly, for precoding 730 either of the precodings 731 and either of the precodings 732 may belong to the same cluster, but neither of the precodings 733 belong to the cluster. In some aspects, a cluster may be determined based on the precoding used for a particular slot such that if one of the precodings 731 was used for a particular slot, a farther of the precodings 732 may not be identified as being in a same cluster, but a closer of the precodings 733 may belong to the cluster. FIG. 7C uses a third threshold (e.g., identified by a value k=3) to identify, for a first precoding 750, that precodings 751, precoding 752, and precodings 753 are similar and may be indicated to be QCL'ed with the first precoding 750. As illustrated in FIGS. 7A-7C, each of the codebook entries (e.g., precodings or precoders) may define a local neighborhood (in a spatial domain) within which all other precoders are expected to result in a similar estimated PDP (as an example of the parameter that may be indicated to be common based on an indicated QCL relationship).

In some aspects, a measure of a distance between precodings and/or precoders (which may be referred to as a precoder distance measure) may be a L1 or L2 norm or any other measure of similarity (such as cosine similarity), and may be selected by the base station. For instance, if P1 and P2 are the normalized precoding vectors applied to the same port index at two different slots, then a base station may declare these two ports to be QCL'ed (with QCL Type E) if μ(P1, P2)≤Δ_{μ}, where μ is a (dis-)similarity measure and Δ_{μ} is the threshold for the measure μ. For example, if μ is a measure of distance between a first precoding (P1) and a second precoding (P2), a similarity criterion for determining that P1 and P2 are similar (and associated ports may be indicated to be QCL'ed) is met when a measure of a distance between the first precoding and the second precoding (e.g., μ(P1, P2)) is one of less than, or equal to, a threshold distance (e.g., μ(P1, P2)≤Δ_{μ}, where Δ_{μ} is the threshold distance).

In some aspects, Δ_{μ} may define the neighborhood in precoder space for a QCL indication (e.g., a QCL Type E indication of a similar parameter for channel estimation such as a PDP or FD correlation). Precoders within same neighborhood of a given precoder may be indicated to be QCL'ed with each other. In some aspects, a choice of Δ_{μ} may depend on an indication from a UE (e.g., an indication of, or based on, a UE's capabilities or preference). For example, UEs able to support a limited number of QCL class indexes may indicate for the base station to use a more relaxed criterion for precoder similarity (e.g., a larger Δ_{μ}). UEs able to support larger numbers of QCL class indexes may allow for finer resolution (e.g., a smaller Δ_{μ}) in precoder dependent QCL indication.

A UE, in some aspects, may report its supported, or preferred, degree of precoder similarity by choosing from a pre-configured number of profiles (similarity profiles). The UE may obtain a plurality of similarity profiles associated with a corresponding plurality of threshold distances. The similarity profiles may be known (e.g., preconfigured) or configured by the base station. Based on the indicated similarity profile (e.g., the indicated supported, or preferred, degree of precoder similarity), the base station may indicate QCL among port-pairs by mapping a selected similarity profile to a corresponding precoder neighborhood criterion (e.g., a threshold distance corresponding to the selected similarity profile). For example, a UE may indicate its supported, or preferred, similarity profile using an index into the plurality of similarity profiles (e.g., a set of K configured similarity profiles) that may be known (e.g., hardcoded or preconfigured) or RRC configured. In some aspects, the UE may include a value (e.g., k∈{1, 2, . . . , K}) in a capability report. The reported value may be selected from a range of values with larger values indicating a larger neighborhood (e.g., a larger distance threshold) or, alternatively, larger values may indicate an ability to handle a larger number of QCL class indexes which may be associated with a smaller neighborhood (e.g., a smaller distance threshold).

While a similarity based on distance was discussed above as an example, in some aspects, based on the similarity measure implemented by the network and/or the base station, the base station may map an indicated value (e.g., k∈{1, 2, . . . , K}) to s similarity threshold, Δ_{μ}, for the precoder based QCL indication (for instance, a smallest threshold may correspond to k=1 and may result in only one precoder per neighborhood while a largest threshold may correspond to k=K and may result in all precoders being determined to be in a same neighborhood). While the mapping from k to Δ_{μ} depends on the choice of precoder similarity measure at the base station, the UE may benefit from knowing the number of precoder clusters associated with each indicated value (e.g., k∈{1, 2, . . . , K}) (and the associated number of signaling bits used to indicate a QCL'ed port or QCL class index in DCI). Accordingly, in some aspects, the base station may indicate, or configure via RRC signaling, the mapping from the possible values (e.g., each k value) to a number of DCI signaling bits used to indicate QCL class indexes. In some aspects, the UE may explicitly indicate a number of supported, or preferred, QCL class indexes (or a number of supported, or preferred, signaling bits).

With the knowledge of the mapping from indicated values to the number of signaling bits and/or the number of QCL class indexes, the UE may then be able to indicate a supported, or preferred, number of signaling bits or to select an indicated value based on a corresponding number of signaling bits. This may result in a direct saving of DCI bits for QCL indication. For example, if a higher indicated value is associated with a larger neighborhood (or larger threshold Δ_{μ}) and a correspondingly smaller number of clusters, fewer bits may be sufficient to indicate the QCL class index. In some aspects, this may be of particular benefit when a supported k value is associated with a number of clusters that is one more than a power of two (e.g., and is associated with an extra bit to cover the possible QCL class indexes) while a next smallest k value is associated with a number of clusters that is the power of two that can be signaled with one less bit. In such a case, a UE may determine to sacrifice the greater similarity between QCL'ed precoders (or precodings) for the benefit of reducing the overhead.

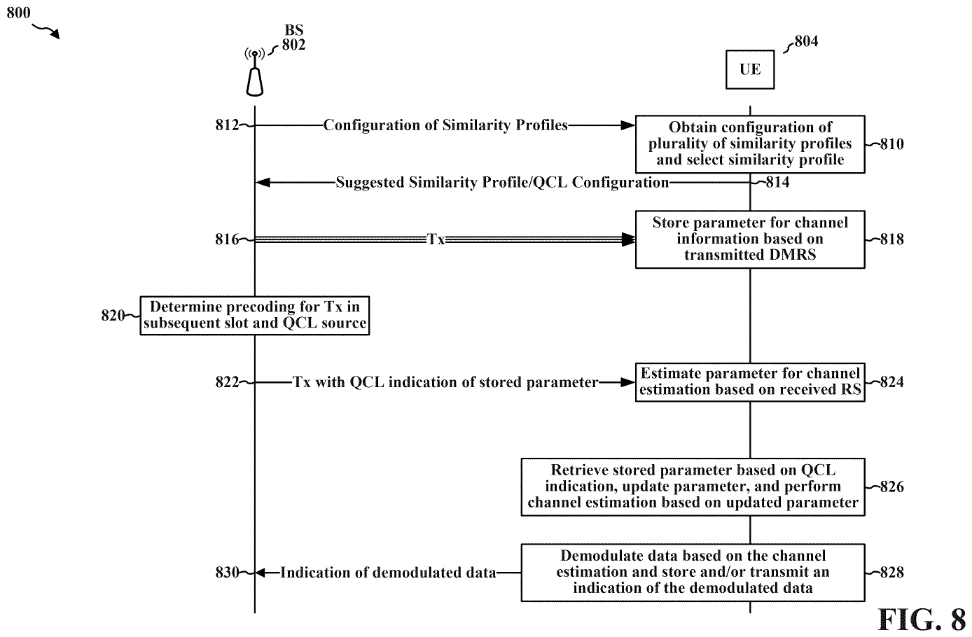

FIG. 8 is a call flow diagram 800 illustrating a method of wireless communication in accordance with some aspects of the disclosure. The method is illustrated in relation to a base station 802 (e.g., as an example of a network device or network node that may include one or more components of a disaggregated base station) in communication with a UE 804 (e.g., as an example of a wireless device). The functions ascribed to the base station 802, in some aspects, may be performed by one or more components of a network entity, a network node, or a network device (a single network entity/node/device or a disaggregated network entity/node/device as described above in relation to FIG. 1). Similarly, the functions ascribed to the UE 804, in some aspects, may be performed by one or more components of a wireless device supporting communication with a network entity/node/device. Accordingly, references to “transmitting” in the description below may be understood to refer to a first component of the base station 802 (or the UE 804) outputting (or providing) an indication of the content of the transmission to be transmitted by a different component of the base station 802 (or the UE 804). Similarly, references to “receiving” in the description below may be understood to refer to a first component of the base station 802 (or the UE 804) receiving a transmitted signal and outputting (or providing) the received signal (or information based on the received signal) to a different component of the base station 802 (or the UE 804).

At 810, the UE 804 may obtain a plurality of similarity associated with a corresponding plurality of threshold distances and select one of the similarity profiles for indicating (or an associated number of signaling bits used to indicate) the QCL for the DMRS or DMRS port (e.g., for QCL Type E indications). The similarity profiles may further be associated with a corresponding plurality of numbers of signaling bits used to indicate a QCL class index. In some aspects, each corresponding threshold distance of the corresponding plurality of threshold distances may be different, while the corresponding plurality of numbers of signaling bits may include one or more numbers of signaling bits that are the same for different similarity profiles. In some aspects, obtaining the plurality of similarity profiles at 810 may include being preconfigured or receiving (e.g., via RRC signaling) a configuration from the base station 802. The base station 802, in some aspects, may transmit a plurality of similarity profiles 812 (or configuration information for the plurality of similarity profiles). The plurality of similarity profiles 812 may include K similarity profiles and an index (k∈{1, 2, . . . , K}) associated with each similarity profile and/or the plurality of similarity profiles 812 may include an indication of the number of signaling bits used to indicate a QCL class index for each of the K similarity profiles (whether preconfigured or RRC configured). The number of signaling bits B may be related to the total number of QCL class indexes K by B=└log₂ K┘. While discussed in relation to signaling bits used to indicate a QCL class, the similarity profiles may be associated with a number of bits used to signal the reference slot, where the number of bits may be associated with the number of signaling bits based on the number of different precoding classes or a maximum number of precodings and/or precoders that could not be valid QCL sources.

As discussed above, the UE may determine, at 810, a supported and/or preferred similarity profile based on a balance between the accuracy of the QCL'ed parameter and the signaling overhead. In some aspects, both the accuracy or similarity of an indicated (shared) parameter (e.g., a PDP or an FD correlation associated with an average delay or average delay spread) and the number of bits used to indicate a QCL class are expected to be inversely correlated with the magnitude of a distance threshold such that improving the accuracy of the QCL'ed parameter may be associated with increasing the signaling overhead and decreasing the signaling overhead may be associated with decreasing the accuracy of the QCL'ed parameter. Based on the selected similarity profile (or number of signaling bits), the UE 804 may transmit, and the base station 802 may receive, an indication 814. The indication 814 may indicate one of a first similarity profile for indicating the type of QCL (e.g., the QCL Type E or the stored parameter) for a subsequent DMRS (or DMRS port or slot) or a first number of signaling bits to use to indicate the QCL'ed DMRS (or DMRS port or slot) or QCL class index.

Based on the indication 814, the base station 802 may transmit one or more transmissions 816 that may be identified as QCL'ed with a subsequent DMRS (or a DMRS port or slot). In some aspects, each of the one or more transmissions 816 may include an indication of a QCL class index using the number of signaling bits based on the indication 814. To perform a demodulation on each transmission of the one or more transmissions 816, the UE 804 may estimate, calculate, and/or compute a parameter (e.g., a PDP or FD correlation) based on an associated DMRS and store, at 818, the parameter for the associated QCL class index. As described in relation to FIGS. 5, 6A, and 6B, in some aspects, the stored parameter may be an updated value based on a previously stored parameter value and the transmission of the one or more transmission 816.

At 820, the base station 802 may determine a precoding for a transmission in a subsequent slot and identify a QCL'ed DMRS (e.g., a transmission of the one or more transmissions 816 including the QCL'ed DMRS) or QCL class index. For example, the base station 802 may determine which transmission of the one or more transmissions 816 should be identified as a QCL'ed with the transmission in the subsequent slot (e.g., which of the one or more transmissions 816 is associated with one of a same QCL class index as the transmission in the subsequent slot or a precoding/precoder in a neighborhood of a precoding/precoder determined for the transmission in the subsequent slot). The identification of the QCL'ed DMRS or QCL class index may be based on the similarity criterion (or multiple similarity criteria) between the QCL'ed DMRSs or between the associated parameter discussed above relating to one of (1) a precoder class or type, (2) a codebook associated with the precoders, or (3) a measure of a distance between precoders/precodings.

For example, when using open loop beamforming, precoders may be identified as being related for the type of QCL (e.g., a QCL class) in at least the following two ways. In some aspects, each of a plurality of candidate QCL classes may be associated with a set of precoders sharing a precoder class or type (e.g., any of a Hadamard precoding, a discrete Fourier transform (DFT) precoding, or cyclic delay diversity (CDD) precoding). In some aspects, when candidate QCL classes are based on using a same precoder class or type, all ports of a first slot may be indicated to be QCL'ed with all ports of the second slot. When using a precoder cycling, each of the plurality of candidate QCL classes may be associated with a different codebook of precoders (e.g., based on the assumption that cycling the precoders of the codebook across PRGs results in a sufficiently similar average FD correlation and/or PDP).

When using closed loop beamforming, precoders may be classified based on a similarity criterion (or multiple similarity criteria), where a codebook resolution in spatial domain may determine the similarity of average PDP estimated based on any two precoders from the codebook. For example, precodings in a codebook may be clustered together to down-size to a set of representative precoders (or precodings) and a base station may identify a first precoding to be similar to a second precoding (e.g., QCL'ed with the second precoding) based on the first and second precodings belonging to a same cluster.

Based on the determined precoding and identified QCL'ed DMRS or QCL class index, the base station 802 may transmit, and the UE 804 may receive, a transmission 822 including a DMRS and a QCL indication, e.g., an indication of a QCL type (e.g., QCL Type E) and a QCL class index (or related DMRS). For example, the transmission 822 may include a first indication of a type of QCL of a first DMRS (e.g., where the first DMRS may be referred to collectively as a first DMRS) of a first port of the associated slot (e.g., a first, or current, slot) with a second DMRS (or second DMRS) of a second port associated with a second slot (where the second slot is a previous slot, e.g., associated with a transmission of the one or more transmissions 816). The first indication of the type of QCL (included in the transmission 822), in some aspects, may be based on a relationship between a first precoding associated with the DMRS of the transmission 822 and a second precoding associated with a QCL'ed transmission of the one or more transmissions 816 (or the QCL'ed DMRS of the transmission of the one or more transmissions 816).

Based on the received transmission 822, and more specifically, based on the DMRS included in the transmission 822, the UE 804 may, at 824, estimate and/or compute a parameter (e.g. a PDP or FD correlation) for the associated channel. Based on the QCL indication included in, or associated with, the transmission 822, the UE 804 may, at 826, retrieve a stored parameter, and update the retrieved parameter based on the DMRS included in the transmission 822 or, more specifically, based on the parameter for the associated channel estimated and/or computed at 824. The update may be associated with an IIR filter as described above, or may be associated with, or based on, a different implementation selecting by the UE 804 for improving the accuracy of the parameter estimation that is consistent with other constraints (e.g., whether the UE supports storing multiple historical values for the parameter and associating each with a corresponding weight for a weighted averaging over time). Updating the parameter at 826, in some aspects, may include storing the updated value for, or corresponding to, the QCL class index or the slot in which the transmission 822 was received. The updated parameter may then be used, at 826, as an input to a channel estimation for the channel.

At 828, the UE 804 may, based on the channel estimation at 826, demodulate and/or decode data included in the transmission 822. Based on the demodulation and/or decoding at 828, the UE may, at 828, output an indication of the demodulated and/or decoded data. Outputting the indication of the demodulated and/or decoded data, in some aspects may include one or more of transmitting an indication of the demodulated and/or decoded data 830 (e.g., where the indication may be a feedback such as a HARQ ACK or NACK), or storing the indication of the demodulated and/or decoded data (e.g., where the indication may be the decoded data).

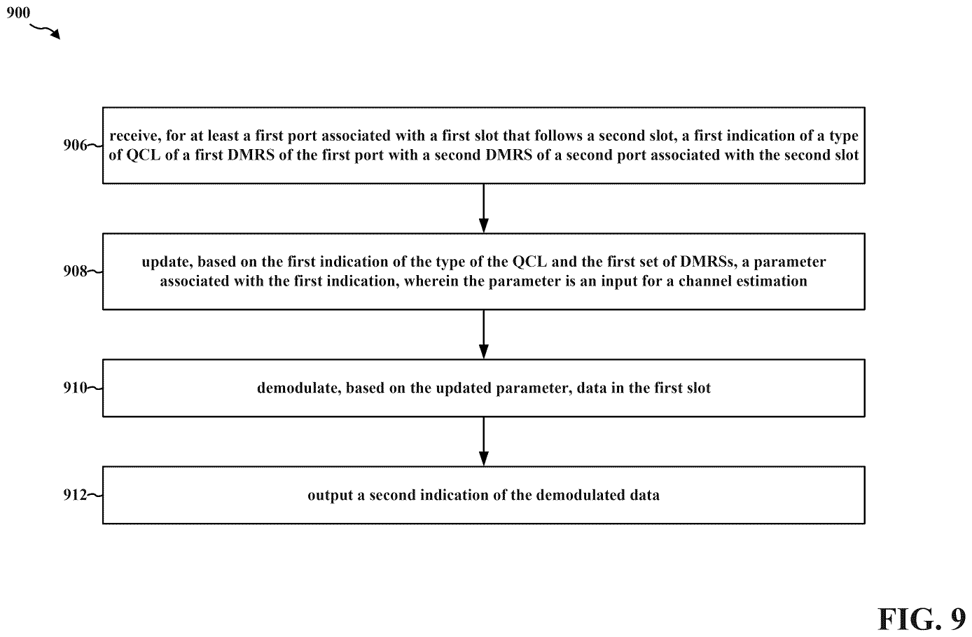

FIG. 9 is a flowchart 900 of a method of wireless communication. The method may be performed by a wireless device such as a UE (e.g., the UE 104, 204, 804; the apparatus 1304). In some aspects, e.g., when using a similarity criterion (or multiple similarity criteria) based on a measure of precoder/precoding similarity, the UE may obtain a plurality of similarity profiles associated with a corresponding plurality of threshold distances. The plurality of similarity thresholds, in some aspects, may be known (or preconfigured) or received, from a network device, via RRC signaling. In some aspects, the plurality of similarity profiles may also be associated with a corresponding number of signaling bits used to indicate a type of QCL of a first DMRS of a first port with a second DMRS of a second port associated with a second (previous) slot. For example, referring to FIG. 8, the UE 804 may, at 810, obtain a plurality of similarity associated with a corresponding plurality of threshold distances. The UE, in some aspects, may transmit, to a network device, an indication of (1) a first similarity profile for indicating the type of QCL for at least the first set of DMRS and/or (2) a first number of signaling bits to use to indicate the second DMRS of the second port of the second slot. In some aspects, each similarity profile may be associated with a corresponding number of signaling bits used to indicate the type of QCL of the first DMRS of the first port with the second DMRS of the second port of the second slot. For example, referring to FIG. 8, the UE 804 may, at 810, select one of the similarity profiles and, based on the selection, transmit an indication 814, where the indication 814 may indicate one of a first similarity profile for indicating the type of QCL (e.g., the QCL Type E or the stored parameter) for a subsequent DMRS (or DMRS port or slot) or a first number of signaling bits to use to indicate the QCL'ed DMRS (or DMRS port or slot) or QCL class index.

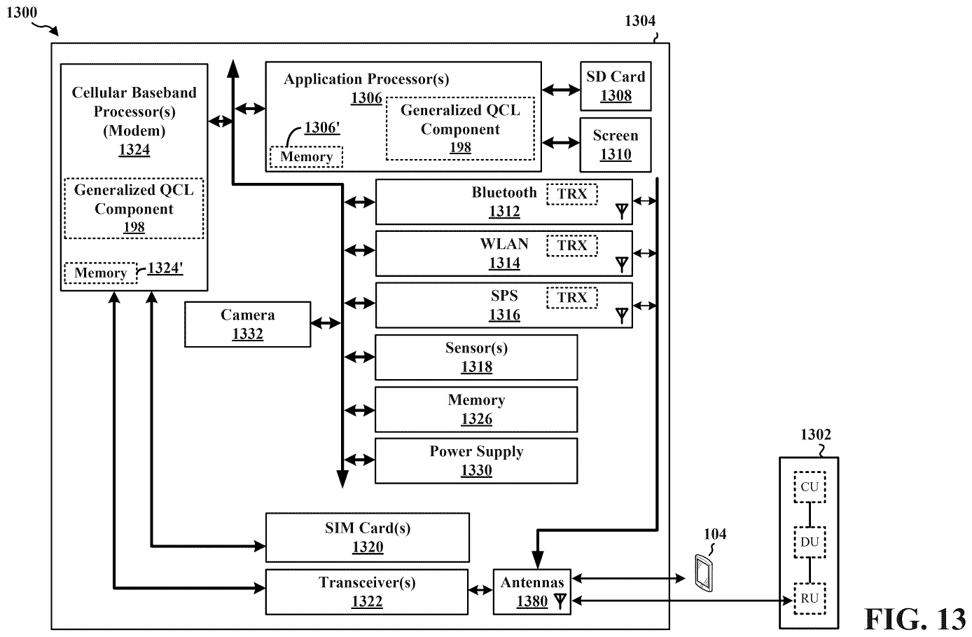

At 906, the UE may receive, for at least a first port associated with a first slot that follows a second slot, a first indication of a type of QCL (e.g., a QCL Type E) of a first DMRS of the first port with a second DMRS of a second port associated with the second slot. In some aspects, the first indication of the type of QCL may be based on a relationship between a first precoding associated with the first DMRS and a second precoding associated with the second DMRS. The first indication may be received from a network device transmitting the DMRS (and data) in the first slot to the UE. For example, 906 may be performed by application processor(s) 1306, cellular baseband processor(s) 1324, transceiver(s) 1322, antenna(s) 1380, and/or component 198 of FIG. 13. In some aspects, the first precoding and the second precoding are based on an open loop beamforming technique, and the relationship between the first precoding and the second precoding comprises an association with one or more of (1) a same precoder class, wherein the same precoder class may be any of a Hadamard precoding, a DFT precoding, or a CDD precoding, or (2) a same codebook of precoders. The relationship between the first precoding and the second precoding, in some aspects, may be the association with the same codebook of precoders, and a plurality of precoders associated with the same codebook of precoders may be cycled across precoding resource groups (PRGs) associated with the first DMRS and the second DMRS. In some aspects, the first DMRS is associated with a first starting PRG offset for cycling the plurality of precoders and the second DMRS is associated with a second starting PRG offset for cycling the plurality of precoders, where the first starting PRG offset may be the same as, or different from, the second starting PRG offset. The first precoding and the second precoding, in some aspects, may be based on a closed loop beamforming technique, and the relationship between the first precoding and the second precoding may be a similarity between the first precoding and the second precoding that meets a similarity criterion (or multiple similarity criteria) for determining that the first precoding and the second precoding are similar. In some aspects, the similarity criterion for determining that the first precoding and the second precoding are similar is met when a measure of a distance between the first precoding and the second precoding is one of less than, or equal to, a threshold distance (e.g., where the threshold distance is a corresponding first threshold distance of a first similarity profile and the first indication is based on the indicated first similarity profile and the corresponding first threshold distance). The first indication, in some aspects, may include a first number of signaling bits associated with the first similarity profile or indicated (explicitly) by the UE. For example, referring to FIG. 8, the UE 804 may receive a transmission 822 in a first slot that may include a first indication of a type of QCL of a first DMRS (e.g., where the first DMRS may be referred to collectively as a first DMRS) of a first port of the associated slot (e.g., a first, or current, slot) with a second DMRS (or second DMRS) of a second port associated with a second slot (where the second slot may be a previous slot, e.g., associated with a transmission of the one or more transmissions 816) where the number of signaling bits used for the first indication may be based on the indication 814.

At 908, the UE may update, based on the first indication of the type of the QCL and the first DMRS, a parameter associated with the first indication. In some aspects, the parameter may be an input for a channel estimation. For example, 908 may be performed by application processor(s) 1306, cellular baseband processor(s) 1324, transceiver(s) 1322, antenna(s) 1380, and/or component 198 of FIG. 13. In some aspects, the parameter may be one of a power delay profile or a frequency domain correlation. For example, referring to FIG. 8, the UE 804 may, at 826, update the retrieved parameter based on the DMRS included in the transmission 822 or, more specifically, based on the parameter for the associated channel estimated and/or computed at 824.

At 910, the UE may demodulate, based on the updated parameter, data in the first slot. For example, 910 may be performed by application processor(s) 1306, cellular baseband processor(s) 1324, transceiver(s) 1322, antenna(s) 1380, and/or component 198 of FIG. 13. For example, referring to FIG. 8, the UE 804 may, at 828, based on the channel estimation at 826, demodulate and/or decode data included in the transmission 822.

At 912, the UE may output a second indication of the demodulated data. For example, 912 may be performed by application processor(s) 1306, cellular baseband processor(s) 1324, transceiver(s) 1322, antenna(s) 1380, and/or component 198 of FIG. 13. In some aspects, outputting the second indication of the demodulated data may include one or more of (1) transmitting the second indication of the demodulated data, or (2) storing the second indication of the demodulated data. For example, referring to FIG. 8, the UE 804 may, at 828, output an indication of the demodulated and/or decoded data. Outputting the indication of the demodulated and/or decoded data, at 828, in some aspects may include one or more of transmitting an indication of the demodulated and/or decoded data 830 (e.g., where the indication may be a feedback such as a HARQ ACK or NACK), or storing the indication of the demodulated and/or decoded data (e.g., where the indication may be the decoded data.

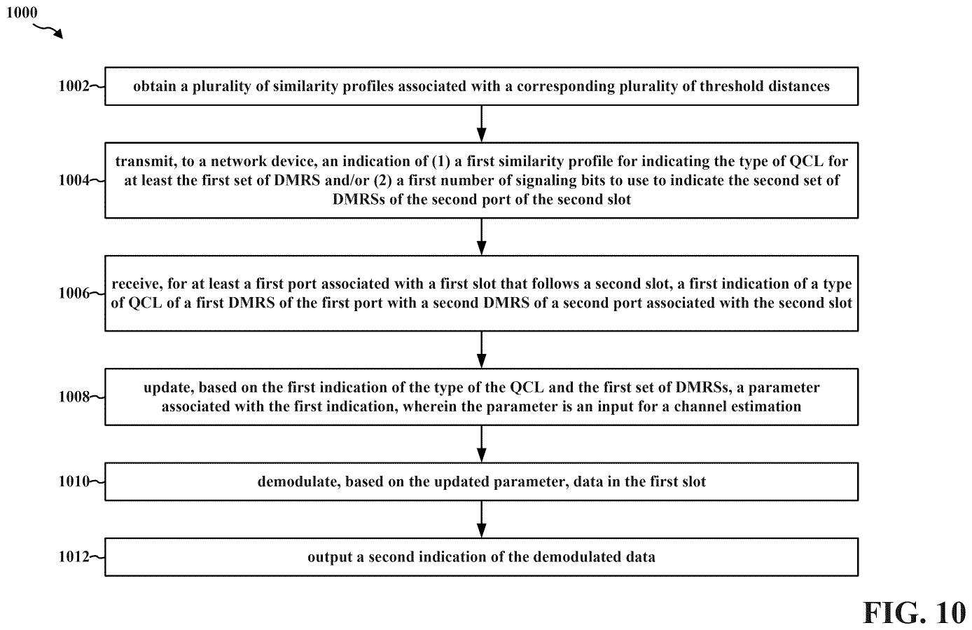

FIG. 10 is a flowchart 1000 of a method of wireless communication. The method may be performed by a wireless device such as a UE (e.g., the UE 104, 204, 804; the apparatus 1304). At 1002, the UE may obtain a plurality of similarity profiles associated with a corresponding plurality of threshold distances. The plurality of similarity thresholds, in some aspects, may be known (or preconfigured) or received, from a network device, via RRC signaling. For example, 1002 may be performed by application processor(s) 1306, cellular baseband processor(s) 1324, transceiver(s) 1322, antenna(s) 1380, and/or component 198 of FIG. 13. In some aspects, the plurality of similarity profiles may also be associated with a corresponding number of signaling bits used to indicate a type of QCL of a first DMRS of a first port with a second DMRS of a second port associated with a second (previous) slot. For example, referring to FIG. 8, the UE 804 may, at 810, obtain a plurality of similarity associated with a corresponding plurality of threshold distances.

At 1004, the UE may transmit, to a network device, an indication of (1) a first similarity profile for indicating the type of QCL for at least the first set of DMRS and/or (2) a first number of signaling bits to use to indicate the second DMRS of the second port of the second slot. For example, 1004 may be performed by application processor(s) 1306, cellular baseband processor(s) 1324, transceiver(s) 1322, antenna(s) 1380, and/or component 198 of FIG. 13. In some aspects, each similarity profile may be associated with a corresponding number of signaling bits used to indicate the type of QCL of the first DMRS of the first port with the second DMRS of the second port of the second slot. For example, referring to FIG. 8, the UE 804 may, at 810, select one of the similarity profiles and, based on the selection, transmit an indication 814, where the indication 814 may indicate one of a first similarity profile for indicating the type of QCL (e.g., the QCL Type E or the stored parameter) for a subsequent DMRS (or DMRS port or slot) or a first number of signaling bits to use to indicate the QCL'ed DMRS (or DMRS port or slot) or QCL class index.

At 1006, the UE may receive, for at least a first port associated with a first slot that follows a second slot, a first indication of a type of QCL (e.g., a QCL Type E) of a first DMRS of the first port with a second DMRS of a second port associated with the second slot. In some aspects, the first indication of the type of QCL may be based on a relationship between a first precoding associated with the first DMRS and a second precoding associated with the second DMRS. The first indication may be received from a network device transmitting the DMRS (and data) in the first slot to the UE. For example, 1006 may be performed by application processor(s) 1306, cellular baseband processor(s) 1324, transceiver(s) 1322, antenna(s) 1380, and/or component 198 of FIG. 13. In some aspects, the first precoding and the second precoding are based on an open loop beamforming technique, and the relationship between the first precoding and the second precoding comprises an association with one or more of (1) a same precoder class, wherein the same precoder class may be any of a Hadamard precoding, a DFT precoding, or a CDD precoding, or (2) a same codebook of precoders. The relationship between the first precoding and the second precoding, in some aspects, may be the association with the same codebook of precoders, and a plurality of precoders associated with the same codebook of precoders may be cycled across precoding resource groups (PRGs) associated with the first DMRS and the second DMRS. In some aspects, the first DMRS is associated with a first starting PRG offset for cycling the plurality of precoders and the second DMRS is associated with a second starting PRG offset for cycling the plurality of precoders, where the first starting PRG offset may be the same as, or different from, the second starting PRG offset. The first precoding and the second precoding, in some aspects, may be based on a closed loop beamforming technique, and the relationship between the first precoding and the second precoding may be a similarity between the first precoding and the second precoding that meets a similarity criterion for determining that the first precoding and the second precoding are similar. In some aspects, the similarity criterion for determining that the first precoding and the second precoding are similar is met when a measure of a distance between the first precoding and the second precoding is one of less than, or equal to, a threshold distance (e.g., where the threshold distance is a corresponding first threshold distance of a first similarity profile and the first indication is based on the indicated first similarity profile and the corresponding first threshold distance). The first indication, in some aspects, may include a first number of signaling bits associated with the first similarity profile or indicated (explicitly) by the UE. For example, referring to FIG. 8, the UE 804 may receive a transmission 822 in a first slot that may include a first indication of a type of QCL of a first DMRS (e.g., where the first DMRS may be referred to collectively as a first DMRS) of a first port of the associated slot (e.g., a first, or current, slot) with a second DMRS (or second DMRS) of a second port associated with a second slot (where the second slot may be a previous slot, e.g., associated with a transmission of the one or more transmissions 816) where the number of signaling bits used for the first indication may be based on the indication 814.

At 1008, the UE may update, based on the first indication of the type of the QCL and the first DMRS, a parameter associated with the first indication. In some aspects, the parameter may be an input for a channel estimation. For example, 1008 may be performed by application processor(s) 1306, cellular baseband processor(s) 1324, transceiver(s) 1322, antenna(s) 1380, and/or component 198 of FIG. 13. In some aspects, the parameter may be one of a power delay profile or a frequency domain correlation. For example, referring to FIG. 8, the UE 804 may, at 826, update the retrieved parameter based on the DMRS included in the transmission 822 or, more specifically, based on the parameter for the associated channel estimated and/or computed at 824.

At 1010, the UE may demodulate, based on the updated parameter, data in the first slot. For example, 1010 may be performed by application processor(s) 1306, cellular baseband processor(s) 1324, transceiver(s) 1322, antenna(s) 1380, and/or component 198 of FIG. 13. For example, referring to FIG. 8, the UE 804 may, at 828, based on the channel estimation at 826, demodulate and/or decode data included in the transmission 822.

At 1012, the UE may output a second indication of the demodulated data. For example, 1012 may be performed by application processor(s) 1306, cellular baseband processor(s) 1324, transceiver(s) 1322, antenna(s) 1380, and/or component 198 of FIG. 13. In some aspects, outputting the second indication of the demodulated data may include one or more of (1) transmitting the second indication of the demodulated data, or (2) storing the second indication of the demodulated data. For example, referring to FIG. 8, the UE 804 may, at 828, output an indication of the demodulated and/or decoded data. Outputting the indication of the demodulated and/or decoded data, at 828, in some aspects may include one or more of transmitting an indication of the demodulated and/or decoded data 830 (e.g., where the indication may be a feedback such as a HARQ ACK or NACK), or storing the indication of the demodulated and/or decoded data (e.g., where the indication may be the decoded data.

In some aspects, the plurality of similarity profiles may also be associated with a corresponding number of signaling bits used to indicate a type of QCL of a first DMRS of a first port with a second DMRS of a second port associated with a second (previous) slot. For example, referring to FIG. 8, the UE 804 may, at 810, obtain a plurality of similarity associated with a corresponding plurality of threshold distances.

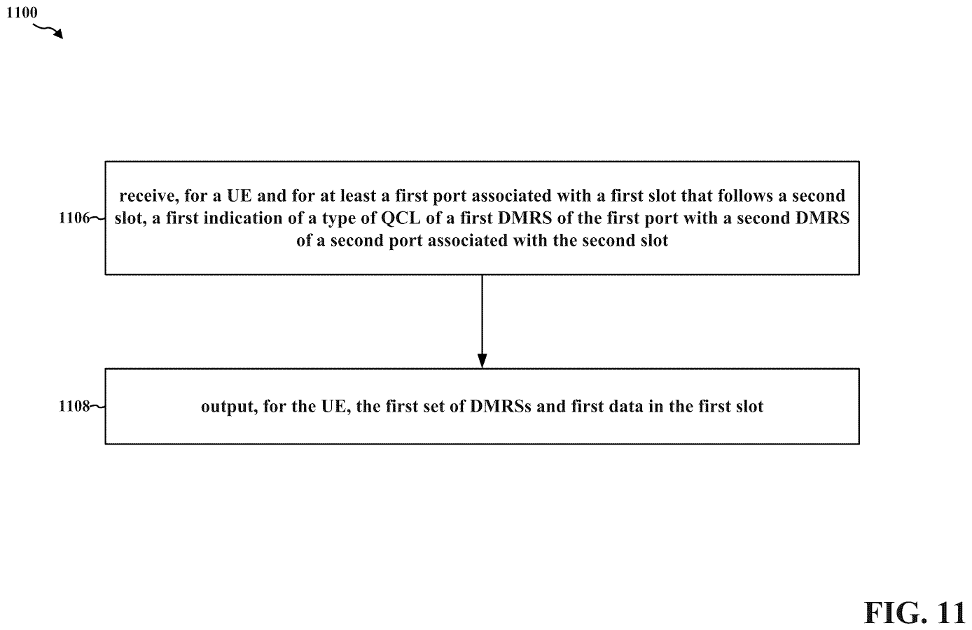

FIG. 11 is a flowchart 1100 of a method of wireless communication. The method may be performed by a network device such as a base station (e.g., the base station 102, 202, 802; the network entity 1302, 1402). In some aspects, the base station may, e.g., when using a similarity criterion based on a measure of precoder/precoding similarity, transmit, for a UE, a plurality of similarity profiles associated with a corresponding plurality of threshold distances. The plurality of similarity thresholds, in some aspects, may be transmitted via RRC signaling. In some aspects, the plurality of similarity profiles may also be associated with a corresponding number of signaling bits used to indicate a type of QCL of a first DMRS of a first port with a second DMRS of a second port associated with a second (previous) slot. For example, referring to FIG. 8, the base station 802 may transmit a plurality of similarity profiles 812 (or configuration information for the plurality of similarity profiles).

In some aspects, the base station may obtain, for the UE, an indication of (1) a first similarity profile for indicating the type of QCL for at least the first set of DMRS and/or (2) a first number of signaling bits to use to indicate the second DMRS of the second port of the second slot. In some aspects, each similarity profile may be associated with a corresponding number of signaling bits used to indicate the type of QCL of the first DMRS of the first port with the second DMRS of the second port of the second slot. For example, referring to FIG. 8, the base station 802 may, at 814, receive an indication 814, where the indication 814 may indicate one of a first similarity profile for indicating the type of QCL (e.g., the QCL Type E or the stored parameter) for a subsequent DMRS (or DMRS port or slot) or a first number of signaling bits to use to indicate the QCL'ed DMRS (or DMRS port or slot) or QCL class index.

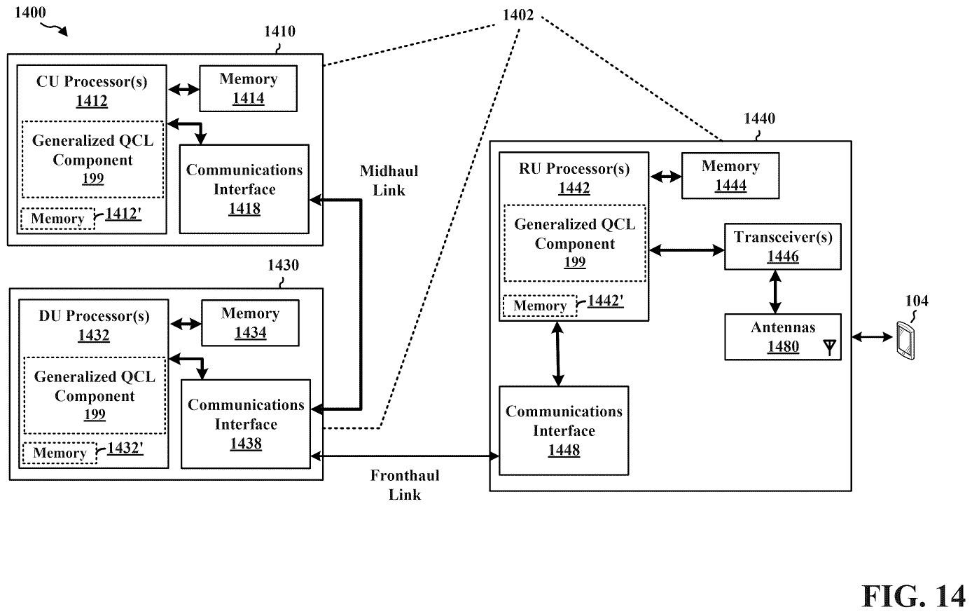

At 1106, the UE may output, for a UE and for at least a first port associated with a first slot that follows a second slot, a first indication of a type of QCL (e.g., a QCL Type E) of a first DMRS of the first port with a second DMRS of a second port associated with the second slot. In some aspects, the first indication of the type of QCL may be based on a relationship between a first precoding associated with the first DMRS and a second precoding associated with the second DMRS. For example, 1106 may be performed by CU processor(s) 1412, DU processor(s) 1432, RU processor(s) 1442, transceiver(s) 1446, antenna(s) 1480, and/or component 199 of FIG. 14. In some aspects, the first precoding and the second precoding are based on an open loop beamforming technique, and the relationship between the first precoding and the second precoding comprises an association with one or more of (1) a same precoder class, wherein the same precoder class may be any of a Hadamard precoding, a DFT precoding, or a CDD precoding, or (2) a same codebook of precoders. The relationship between the first precoding and the second precoding, in some aspects, may be the association with the same codebook of precoders, and a plurality of precoders associated with the same codebook of precoders may be cycled across precoding resource groups (PRGs) associated with the first DMRS and the second DMRS. In some aspects, the first DMRS is associated with a first starting PRG offset for cycling the plurality of precoders and the second DMRS is associated with a second starting PRG offset for cycling the plurality of precoders, where the first starting PRG offset may be the same as, or different from, the second starting PRG offset. The first precoding and the second precoding, in some aspects, may be based on a closed loop beamforming technique, and the relationship between the first precoding and the second precoding may be a similarity between the first precoding and the second precoding that meets a similarity criterion for determining that the first precoding and the second precoding are similar. In some aspects, the similarity criterion for determining that the first precoding and the second precoding are similar is met when a measure of a distance between the first precoding and the second precoding is one of less than, or equal to, a threshold distance (e.g., where the threshold distance is a corresponding first threshold distance of a first similarity profile and the first indication is based on the indicated first similarity profile and the corresponding first threshold distance). The first indication, in some aspects, may include a first number of signaling bits associated with the first similarity profile or indicated (explicitly) by, or for, the UE. For example, referring to FIG. 8, the base station 802 may transmit a transmission 822 in a first slot that may include a first indication of a type of QCL of a first DMRS (e.g., where the first DMRS may be referred to collectively as a first DMRS) of a first port of the associated slot (e.g., a first, or current, slot) with a second DMRS (or second DMRS) of a second port associated with a second slot (where the second slot may be a previous slot, e.g., associated with a transmission of the one or more transmissions 816) where the number of signaling bits used for the first indication may be based on the indication 814.

At 1108, the base station may output the first DMRS and first data in the first slot. For example, 1108 may be performed by CU processor(s) 1412, DU processor(s) 1432, RU processor(s) 1442, transceiver(s) 1446, antenna(s) 1480, and/or component 199 of FIG. 14. In some aspects, the parameter may be one of a power delay profile or a frequency domain correlation. For example, referring to FIG. 8, the base station 802 may transmit a transmission 822 including a DMRS.

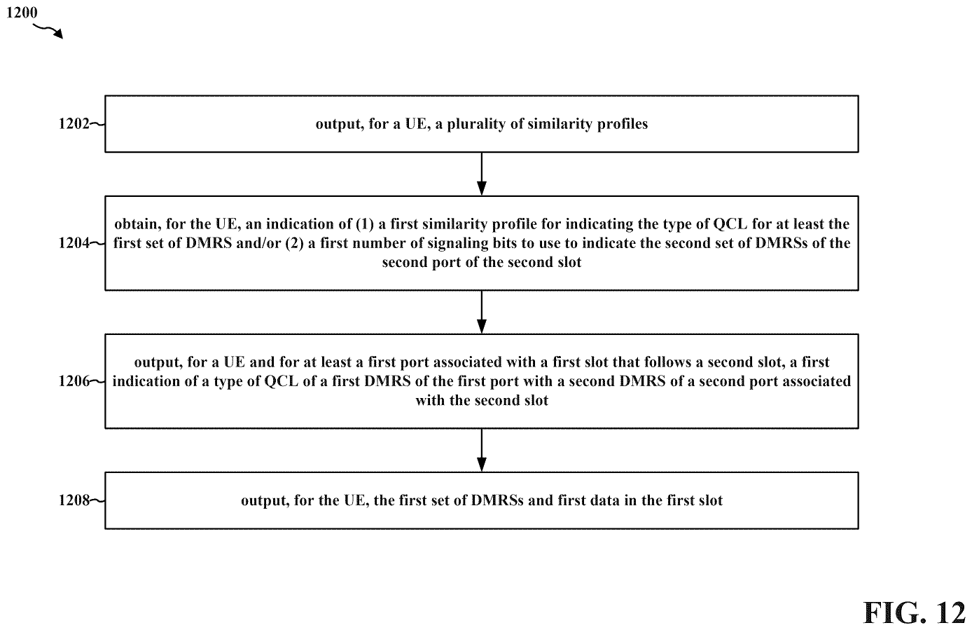

FIG. 12 is a flowchart 1200 of a method of wireless communication. The method may be performed by a network device such as a base station (e.g., the base station 102, 202, 802; the network entity 1302, 1402). At 1202, the base station may, e.g., when using a similarity criterion (or multiple similarity criteria) based on a measure of precoder/precoding similarity, transmit, for a UE, a plurality of similarity profiles associated with a corresponding plurality of threshold distances. The plurality of similarity thresholds, in some aspects, may be transmitted via RRC signaling. For example, 1202 may be performed by CU processor(s) 1412, DU processor(s) 1432, RU processor(s) 1442, transceiver(s) 1446, antenna(s) 1480, and/or component 199 of FIG. 14. In some aspects, the plurality of similarity profiles may also be associated with a corresponding number of signaling bits used to indicate a type of QCL of a first DMRS of a first port with a second DMRS of a second port associated with a second (previous) slot. For example, referring to FIG. 8, the base station 802 may transmit a plurality of similarity profiles 812 (or configuration information for the plurality of similarity profiles).

At 1204, the base station may obtain, for the UE, an indication of (1) a first similarity profile for indicating the type of QCL for at least the first set of DMRS and/or (2) a first number of signaling bits to use to indicate the second DMRS of the second port of the second slot. For example, 1204 may be performed by CU processor(s) 1412, DU processor(s) 1432, RU processor(s) 1442, transceiver(s) 1446, antenna(s) 1480, and/or component 199 of FIG. 14. In some aspects, each similarity profile may be associated with a corresponding number of signaling bits used to indicate the type of QCL of the first DMRS of the first port with the second DMRS of the second port of the second slot. For example, referring to FIG. 8, the base station 802 may, at 814, receive an indication 814, where the indication 814 may indicate one of a first similarity profile for indicating the type of QCL (e.g., the QCL Type E or the stored parameter) for a subsequent DMRS (or DMRS port or slot) or a first number of signaling bits to use to indicate the QCL'ed DMRS (or DMRS port or slot) or QCL class index.

At 1206, the UE may output, for a UE and for at least a first port associated with a first slot that follows a second slot, a first indication of a type of QCL (e.g., a QCL Type E) of a first DMRS of the first port with a second DMRS of a second port associated with the second slot. In some aspects, the first indication of the type of QCL may be based on a relationship between a first precoding associated with the first DMRS and a second precoding associated with the second DMRS. For example, 1206 may be performed by CU processor(s) 1412, DU processor(s) 1432, RU processor(s) 1442, transceiver(s) 1446, antenna(s) 1480, and/or component 199 of FIG. 14. In some aspects, the first precoding and the second precoding are based on an open loop beamforming technique, and the relationship between the first precoding and the second precoding comprises an association with one or more of (1) a same precoder class, wherein the same precoder class may be any of a Hadamard precoding, a DFT precoding, or a CDD precoding, or (2) a same codebook of precoders. The relationship between the first precoding and the second precoding, in some aspects, may be the association with the same codebook of precoders, and a plurality of precoders associated with the same codebook of precoders may be cycled across precoding resource groups (PRGs) associated with the first DMRS and the second DMRS. In some aspects, the first DMRS is associated with a first starting PRG offset for cycling the plurality of precoders and the second DMRS is associated with a second starting PRG offset for cycling the plurality of precoders, where the first starting PRG offset may be the same as, or different from, the second starting PRG offset. The first precoding and the second precoding, in some aspects, may be based on a closed loop beamforming technique, and the relationship between the first precoding and the second precoding may be a similarity between the first precoding and the second precoding that meets a similarity criterion for determining that the first precoding and the second precoding are similar. In some aspects, the similarity criterion for determining that the first precoding and the second precoding are similar is met when a measure of a distance between the first precoding and the second precoding is one of less than, or equal to, a threshold distance (e.g., where the threshold distance is a corresponding first threshold distance of a first similarity profile and the first indication is based on the indicated first similarity profile and the corresponding first threshold distance). The first indication, in some aspects, may include a first number of signaling bits associated with the first similarity profile or indicated (explicitly) by, or for, the UE. For example, referring to FIG. 8, the base station 802 may transmit a transmission 822 in a first slot that may include a first indication of a type of QCL of a first DMRS (e.g., where the first DMRS may be referred to collectively as a first DMRS) of a first port of the associated slot (e.g., a first, or current, slot) with a second DMRS (or second DMRS) of a second port associated with a second slot (where the second slot may be a previous slot, e.g., associated with a transmission of the one or more transmissions 816) where the number of signaling bits used for the first indication may be based on the indication 814.

At 1208, the base station may output the first DMRS and first data in the first slot. For example, 1208 may be performed by CU processor(s) 1412, DU processor(s) 1432, RU processor(s) 1442, transceiver(s) 1446, antenna(s) 1480, and/or component 199 of FIG. 14. In some aspects, the parameter may be one of a power delay profile or a frequency domain correlation. For example, referring to FIG. 8, the base station 802 may transmit a transmission 822 including a DMRS.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 450 and may include the at least one memory 460 and/or at least one of the TX processor 468, the RX processor 456, and the controller/processor 459. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 450 of FIG. 4) and include the additional modules of the apparatus 1304.

As discussed supra, the generalized QCL component 198 may be configured to receive, for at least a first port associated with a first slot that follows a second slot, a first indication of a type of QCL of a first DMRS of the first port with a second DMRS of a second port associated with the second slot, wherein the first indication of the type of QCL is based on a relationship between a first precoding associated with the first DMRS and a second precoding associated with the second DMRS, update, based on the first DMRS, a parameter associated with the first indication, wherein the parameter is an input for a channel estimation, demodulate, based on the updated parameter, data in the first slot, and output a second indication of the demodulated data. The generalized QCL component 198 may be within the cellular baseband processor(s) 1324, the application processor(s) 1306, or both the cellular baseband processor(s) 1324 and the application processor(s) 1306. The generalized QCL component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, for at least a first port associated with a first slot that follows a second slot, a first indication of a type of quasi-co-location (QCL) of a first set of demodulation reference signals (DMRSs) of the first port with a second set of DMRSs of a second port associated with the second slot, wherein the first indication of the type of QCL is based on a relationship between a first precoding associated with the first set of DMRSs and a second precoding associated with the second set of DMRSs. The apparatus 1304, and in particular the cellular baseband processor(s) 1324 and/or the application processor(s) 1306, may include means for updating, based on the first indication of the type of the QCL and the first set of DMRSs, a parameter associated with the first indication, wherein the parameter is an input for a channel estimation. The apparatus 1304, and in particular the cellular baseband processor(s) 1324 and/or the application processor(s) 1306, may include means for demodulating, based on the updated parameter, data in the first slot. The apparatus 1304, and in particular the cellular baseband processor(s) 1324 and/or the application processor(s) 1306, may include means for outputting a second indication of the demodulated data. The apparatus 1304, and in particular the cellular baseband processor(s) 1324 and/or the application processor(s) 1306, may include means for obtaining a plurality of similarity profiles associated with a corresponding plurality of threshold distances. The apparatus 1304, and in particular the cellular baseband processor(s) 1324 and/or the application processor(s) 1306, may include means for transmitting, to a network device, an additional indication of a first similarity profile for indicating the type of QCL for at least the first set of DMRSs, wherein the first indication is based on the first similarity profile and a corresponding first threshold distance. The apparatus 1304, and in particular the cellular baseband processor(s) 1324 and/or the application processor(s) 1306, may include means for transmitting, to a network device, an additional indication of a first number of signaling bits to use to indicate the second set of DMRSs of the second port of the second slot, wherein the first indication comprises the first number of signaling bits. The apparatus 1304, and in particular the cellular baseband processor(s) 1324 and/or the application processor(s) 1306, may include means for transmitting the second indication of the demodulated data. The apparatus 1304, and in particular the cellular baseband processor(s) 1324 and/or the application processor(s) 1306, may include means for storing the second indication of the demodulated data. The apparatus 1304 may further include means for performing any of the aspects described in connection with the flowcharts in FIG. 9 or 10, and/or performed by the UE in the communication flow of FIG. 8. The means may be the generalized QCL component 198 of the apparatus 1304 configured to perform the functions recited by the means. As described supra, the apparatus 1304 may include the TX processor 468, the RX processor 456, and the controller/processor 459. As such, in one configuration, the means may be the TX processor 468, the RX processor 456, and/or the controller/processor 459 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the generalized QCL component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the generalized QCL component 199 may be configured to output, for a UE and for at least a first port associated with a first slot following a second slot, a first indication of a type of QCL of a first DMRSs of the first port with a second DMRS of a second port associated with the second slot, wherein the indication of the type of QCL is based on a relationship between a first precoding associated with the first DMRS and a second precoding associated with the second DMRS, and output, for the UE, the first DMRS and first data in the first slot. The generalized QCL component 199 may be within one or more processors of one or more of the CU 1410, DU 1430, and the RU 1440. The generalized QCL component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for outputting, for a user equipment (UE) and for at least a first port associated with a first slot following a second slot, a first indication of a type of quasi-co-location (QCL) of a first set of demodulation reference signals (DMRSs) of the first port with a second set of DMRSs of a second port associated with the second slot, wherein the indication of the type of QCL is based on a relationship between a first precoding associated with the first set of DMRSs and a second precoding associated with the second set of DMRSs. The network entity 1402 may include means for outputting, for the UE, the first set of DMRSs and first data in the first slot. The network entity 1402 may include means for obtaining, for the UE, an additional indication of a first similarity profile for indicating the type of QCL for at least the first set of DMRSs, wherein the first indication is based on the first similarity profile and a corresponding first threshold distance. The network entity 1402 may include means for outputting, for the UE, the plurality of similarity profiles. The network entity 1402 may include means for obtaining, for the UE, an additional indication of a first number of signaling bits to use to indicate the second set of DMRSs of the second port of the second slot, wherein the first indication comprises the first number of signaling bits. The network entity 1402 may further include means for performing any of the aspects described in connection with the flowcharts in FIGS. 11 and 12, and/or performed by the base station in the communication flow of FIG. 8. The means may be the generalized QCL component 199 of the network entity 1402 configured to perform the functions recited by the means. As described supra, the network entity 1402 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving, for at least a first port associated with a first slot that follows a second slot, a first indication of a type of quasi-co-location (QCL) of a first demodulation reference signal (DMRS) of the first port with a second DMRS of a second port associated with the second slot, wherein the first indication of the type of QCL is based on a relationship between a first precoding associated with the first DMRS and a second precoding associated with the second DMRS; updating, based on the first indication of the type of the QCL and the first DMRS, a parameter associated with the first indication, wherein the parameter is an input for a channel estimation; demodulating, based on the updated parameter, data in the first slot; and outputting a second indication of the demodulated data.

Aspect 2 is the method of aspect of any of aspects 1, wherein the parameter is one of a power delay profile or a frequency domain correlation.

Aspect 3 is the method of any of aspects 1 and 2, wherein the first precoding and the second precoding are based on an open loop beamforming technique, and wherein the relationship between the first precoding and the second precoding comprises an association with one or more of: a same precoder class, wherein the same precoder class is any of a Hadamard precoding, a discrete Fourier transform (DFT) precoding, or a cyclic delay diversity (CDD) precoding; or a same codebook of precoders.

Aspect 4 is the method of any of aspects 1 and 2, wherein the first precoding and the second precoding are based on an open loop beamforming technique, and wherein the relationship between the first precoding and the second precoding comprises an association with a same precoder class, wherein the same precoder class is a Hadamard precoding.

Aspect 5 is the method of any of aspects 1 and 2, wherein the first precoding and the second precoding are based on an open loop beamforming technique, and wherein the relationship between the first precoding and the second precoding comprises an association with a same precoder class, wherein the same precoder class is a discrete Fourier transform (DFT) precoding.

Aspect 6 is the method of any of aspects 1 and 2, wherein the first precoding and the second precoding are based on an open loop beamforming technique, and wherein the relationship between the first precoding and the second precoding comprises an association with a same precoder class, wherein the same precoder class is a cyclic delay diversity (CDD) precoding.

Aspect 7 is the method of any of aspects 1 and 2, wherein the first precoding and the second precoding are based on an open loop beamforming technique, and wherein the relationship between the first precoding and the second precoding comprises an association with a same codebook of precoders.

Aspect 8 is the method of aspect 3, wherein the relationship between the first precoding and the second precoding comprises the association with the same codebook of precoders, wherein a plurality of precoders associated with the same codebook of precoders are cycled across precoding resource groups (PRGs) associated with the first DMRS and the second DMRS, wherein the first DMRS is associated with a first starting PRG offset for cycling the plurality of precoders and the second DMRS is associated with a second starting PRG offset for cycling the plurality of precoders.

Aspect 9 is the method of aspect 1, wherein the first precoding and the second precoding are based on a closed loop beamforming technique, and wherein the relationship between the first precoding and the second precoding comprises a similarity between the first precoding and the second precoding that meets a similarity criterion for determining that the first precoding and the second precoding are similar.

Aspect 10 is the method of aspect 9, wherein the similarity criterion for determining that the first precoding and the second precoding are similar is met when a measure of a distance between the first precoding and the second precoding is one of less than, or equal to, a threshold distance.

Aspect 11 is the method of aspect of any of aspects 9, further comprising: obtaining a plurality of similarity profiles associated with a corresponding plurality of threshold distances; and transmitting, to a network device, an additional indication of a first similarity profile for indicating the type of QCL for at least the first DMRS, wherein the first indication is based on the first similarity profile and a corresponding first threshold distance.

Aspect 12 is the method of aspect of any of aspects 11, wherein each similarity profile is associated with a corresponding number of signaling bits used to indicate the second DMRS of the second port of the second slot, and wherein the first indication of the type of QCL comprises a first number of signaling bits associated with the first similarity profile.

Aspect 13 is the method of aspect of any of aspects 9, further comprising: transmitting, to a network device, an additional indication of a first number of signaling bits to use to indicate the second DMRS of the second port of the second slot, wherein the first indication comprises the first number of signaling bits.

Aspect 14 is the method of aspect of any of aspects 1, wherein outputting the second indication of the demodulated data comprises transmitting the second indication of the demodulated data.

Aspect 15 is the method of aspect of any of aspects 1, wherein outputting the second indication of the demodulated data comprises storing the second indication of the demodulated data.

Aspect 16. A method of wireless communication at a network device, comprising: outputting, for a user equipment (UE) and for at least a first port associated with a first slot following a second slot, a first indication of a type of quasi-co-location (QCL) of a first demodulation reference signal (DMRS) of the first port with a second DMRS of a second port associated with the second slot, wherein the indication of the type of QCL is based on a relationship between a first precoding associated with the first DMRS and a second precoding associated with the second DMRS; and outputting, for the UE, the first DMRS and first data in the first slot.

Aspect 17 is the method of aspect of any of aspects 16, wherein the relationship between the first precoding and the second precoding comprises an association with one or more of: a same precoder class, wherein the same precoder class is one of a Hadamard precoding, a discrete Fourier transform (DFT) precoding, or a cyclic delay diversity (CDD) precoding, or a combination thereof; or a same codebook of precoders.

Aspect 18 is the method of aspect of any of aspects 16, wherein the relationship between the first precoding and the second precoding comprises an association with a same precoder class, wherein the same precoder class is a Hadamard precoding.

Aspect 19 is the method of aspect of any of aspects 16, wherein the relationship between the first precoding and the second precoding comprises an association with a same precoder class, wherein the same precoder class is a discrete Fourier transform (DFT) precoding.

Aspect 20 is the method of aspect of any of aspects 16, wherein the relationship between the first precoding and the second precoding comprises an association with a same precoder class, wherein the same precoder class is a cyclic delay diversity (CDD) precoding.

Aspect 21 is the method of aspect of any of aspects 16, wherein the relationship between the first precoding and the second precoding comprises an association with a same codebook of precoders.

Aspect 22 is the method of aspect of any of aspects 17, wherein the relationship between the first precoding and the second precoding comprises the association with the same codebook of precoders, wherein a plurality of precoders associated with the codebook of precoders are cycled across precoding resource groups (PRGs) associated with the first DMRS and the second DMRS, wherein the first DMRS is associated with a first starting PRG offset for cycling the plurality of precoders and the second DMRS is associated with a second starting PRG offset for cycling the plurality of precoders.

Aspect 23 is the method of aspect of any of aspects 16, wherein the first precoding and the second precoding are based on a closed loop beamforming technique, and wherein the relationship between the first precoding and the second precoding comprises a similarity between the first precoding and the second precoding that meets a similarity criterion for determining that the first precoding and the second precoding are similar.

Aspect 24 is the method of aspect of any of aspects 23, wherein the similarity criterion for determining that the first precoding and the second precoding are similar is met when a measure of a distance between the first precoding and the second precoding is one of less than, or equal to, a threshold distance.

Aspect 25 is the method of aspect of any of aspects 23, wherein a plurality of similarity profiles associated with a corresponding plurality of threshold distances is known to the UE, the method further comprising: obtaining, for the UE, an additional indication of a first similarity profile for indicating the type of QCL for at least the first DMRS, wherein the first indication is based on the first similarity profile and a corresponding first threshold distance.

Aspect 26 is the method of aspect of any of aspects 25, wherein each similarity profile is associated with a corresponding number of signaling bits used to indicate the second DMRS of the second port of the second slot, and wherein the first indication of the type of QCL comprises a first number of signaling bits associated with the first similarity profile.

Aspect 27 is the method of aspect of any of aspects 25, further comprising: outputting, for the UE, the plurality of similarity profiles.

Aspect 28 is the method of aspect of any of aspects 23, further comprising: obtaining, for the UE, an additional indication of a first number of signaling bits to use to indicate the second DMRS of the second port of the second slot, wherein the first indication comprises the first number of signaling bits.

What is claimed is:

1. An apparatus for wireless communication at a user equipment (UE), comprising:
one or more memories; and
one or more processors coupled to the one or more memories and configured to cause the UE to:
receive, for at least a first port associated with a first slot that follows a second slot, a first indication of a type of quasi-co-location (QCL) of a first demodulation reference signal (DMRS) of the first port with a second DMRS of a second port associated with the second slot, wherein the first indication of the type of QCL is based on a relationship between a first precoding associated with the first DMRS and a second precoding associated with the second DMRS;
update, based on the first indication of the type of the QCL and the first DMRS, a parameter associated with the first indication, wherein the parameter is an input for a channel estimation;
demodulate, based on the updated parameter, data in the first slot; and
output a second indication of the demodulated data.

2. The apparatus of claim 1, wherein the parameter is one of a power delay profile or a frequency domain correlation.

3. The apparatus of claim 1, wherein the first precoding and the second precoding are based on an open loop beamforming technique, and wherein the relationship between the first precoding and the second precoding comprises an association with one or more of:
a same precoder class, wherein the same precoder class is any of a Hadamard precoding, a discrete Fourier transform (DFT) precoding, or a cyclic delay diversity (CDD) precoding; or
a same codebook of precoders.

4. The apparatus of claim 3, wherein the relationship between the first precoding and the second precoding comprises the association with the same codebook of precoders, wherein a plurality of precoders associated with the same codebook of precoders are cycled across precoding resource groups (PRGs) associated with the first DMRS and the second DMRS, wherein the first DMRS is associated with a first starting PRG offset for cycling the plurality of precoders and the second DMRS is associated with a second starting PRG offset for cycling the plurality of precoders.

5. The apparatus of claim 1, wherein the first precoding and the second precoding are based on a closed loop beamforming technique, and wherein the relationship between the first precoding and the second precoding comprises a similarity between the first precoding and the second precoding that meets a similarity criterion for determining that the first precoding and the second precoding are similar.

6. The apparatus of claim 5, wherein the similarity criterion for determining that the first precoding and the second precoding are similar is met when a measure of a distance between the first precoding and the second precoding is one of less than, or equal to, a threshold distance.

7. The apparatus of claim 5, further comprising one or more antennas coupled to the one or more processors, wherein the one or more processors are further configured to cause the UE to:
obtain a plurality of similarity profiles associated with a corresponding plurality of threshold distances; and
transmit, to a network device via the one or more antennas, an additional indication of a first similarity profile for indicating the type of QCL for at least the first DMRS, wherein the first indication is based on the first similarity profile and a corresponding first threshold distance.

8. The apparatus of claim 7, wherein each similarity profile is associated with a corresponding number of signaling bits used to indicate the second DMRS of the second port of the second slot, and wherein the first indication of the type of QCL comprises a first number of signaling bits associated with the first similarity profile.

9. The apparatus of claim 5, wherein the one or more processors are further configured to cause the UE to:
transmit, to a network device, an additional indication of a first number of signaling bits to use to indicate the second DMRS of the second port of the second slot, wherein the first indication comprises the first number of signaling bits.

10. A method of wireless communication at a user equipment (UE), comprising:
receiving, for at least a first port associated with a first slot that follows a second slot, a first indication of a type of quasi-co-location (QCL) of a first demodulation reference signal (DMRS) of the first port with a second DMRS of a second port associated with the second slot, wherein the first indication of the type of QCL is based on a relationship between a first precoding associated with the first DMRS and a second precoding associated with the second DMRS;
updating, based on the first indication of the type of the QCL and the first DMRS, a parameter associated with the first indication, wherein the parameter is an input for a channel estimation;
demodulating, based on the updated parameter, data in the first slot; and
outputting a second indication of the demodulated data.

11. The method of claim 10, wherein the parameter is one of a power delay profile or a frequency domain correlation.

12. The method of claim 10, wherein the first precoding and the second precoding are based on an open loop beamforming technique, and wherein the relationship between the first precoding and the second precoding comprises an association with one or more of:
a same precoder class, wherein the same precoder class is any of a Hadamard precoding, a discrete Fourier transform (DFT) precoding, or a cyclic delay diversity (CDD) precoding; or
a same codebook of precoders.

13. The method of claim 12, wherein the relationship between the first precoding and the second precoding comprises the association with the same codebook of precoders, wherein a plurality of precoders associated with the same codebook of precoders are cycled across precoding resource groups (PRGs) associated with the first DMRS and the second DMRS, wherein the first DMRS is associated with a first starting PRG offset for cycling the plurality of precoders and the second DMRS is associated with a second starting PRG offset for cycling the plurality of precoders.

14. The method of claim 10, wherein the first precoding and the second precoding are based on a closed loop beamforming technique, and wherein the relationship between the first precoding and the second precoding comprises a similarity between the first precoding and the second precoding that meets a similarity criterion for determining that the first precoding and the second precoding are similar.

15. The method of claim 14, wherein the similarity criterion for determining that the first precoding and the second precoding are similar is met when a measure of a distance between the first precoding and the second precoding is one of less than, or equal to, a threshold distance.

16. The method of claim 14, further comprising:
obtaining a plurality of similarity profiles associated with a corresponding plurality of threshold distances; and
transmitting, to a network device, an additional indication of a first similarity profile for indicating the type of QCL for at least the first DMRS, wherein the first indication is based on the first similarity profile and a corresponding first threshold distance.

17. The method of claim 16, wherein each similarity profile is associated with a corresponding number of signaling bits used to indicate the second DMRS of the second port of the second slot, and wherein the first indication of the type of QCL comprises a first number of signaling bits associated with the first similarity profile.

18. The method of claim 14, further comprising:
transmitting, to a network device, an additional indication of a first number of signaling bits to use to indicate the second DMRS of the second port of the second slot, wherein the first indication comprises the first number of signaling bits.

19. A method of wireless communication at a network device, comprising:
outputting, for a user equipment (UE) and for at least a first port associated with a first slot following a second slot, a first indication of a type of quasi-co-location (QCL) of a first demodulation reference signal (DMRS) of the first port with a second DMRS of a second port associated with the second slot, wherein the indication of the type of QCL is based on a relationship between a first precoding associated with the first DMRS and a second precoding associated with the second DMRS; and
outputting, for the UE, the first DMRS and first data in the first slot.

20. The method of claim 19, wherein the relationship between the first precoding and the second precoding comprises one or more of:
being associated with a same precoder class, wherein the same precoder class is one of a Hadamard precoding, a discrete Fourier transform (DFT) precoding, or a cyclic delay diversity (CDD) precoding, or a combination thereof;
being associated with a same codebook of precoders; and
a similarity between the first precoding and the second precoding that meets a similarity criterion for determining that the first precoding and the second precoding are similar.
